(19) United States
(12) Patent Application Publication
(10) Pub. No.: US 2024/0030834 A1
(43) Pub. Date: Jan. 25, 2024

(54) EFFICIENT DRIVE FOR PIEZOELECTRIC INERTIA MOTORS

(71) Applicant: PHYSIK INSTRUMENTE (PI) GMBH & CO. KG, Karlsruhe (DE)

(72) Inventors: Burhanettin KOC, Ettlingen (DE); Sebastian KIST, Walldorf (DE)

(21) Appl. No.: 18/265,631

(22) PCT Filed: Nov. 29, 2021
(86) PCT No.: PCT/EP2021/083293

§ 371 Date: Jun. 6, 2023

(30) Foreign Application Priority Data
Dec. 8, 2020 (DE) 10 2020 132 640.8

(51) Int. Cl. H02N 2/06; H02N 2/02

(52) U.S. Cl. CPC H02N 2/067; H02N 2/025

(57) ABSTRACT

A control device and a control method for a piezoelectric inertia motor are provided. In the stick phase, a first switching element and a second switching element are switched in directions opposite to one another by pulse width modulation, where a time component of a first switching state of ON and OFF increases relative to a time component of a second switching state of ON and OFF, the pulse width modulation is filtered by the capacitive piezoelectric actuator and an inductance, and a first charging operation is carried out, and the time components of the first switching state and the second switching state are reversed at the beginning of a slip phase, and thereby carrying out a second charging operation in the opposite direction to the first charging operation at the capacitive piezoelectric actuator. By storing electromagnetic energy in the inductance, the configuration provided allows for the reduction of energy dissipation as heat and can contribute to an energy-efficient drive for inertia motors.

### CROSS REFERENCE TO RELATED APPLICATIONS

This application is a U.S. National Phase Application under 35 U.S.C. 371 of International Application No. PCT/EP2021/083293, filed on Nov. 29, 2021, which claims priority to German Patent Application No. 10 2020 132 640.8, filed on Dec. 8, 2020. The entire disclosures of the above applications are expressly incorporated by reference herein.

### BACKGROUND

### Technical Field

The present invention relates to a control device as well as to a control method for a piezoelectric inertia motor.

### Related Art

In piezoelectric motors with an inertia drive, the tangential component of reciprocating motion generates a motion at a contact between a slider and a stator. In one direction of tangential motion, the stator element is slowly activated. During this activation period, the “stick phase” or “slow phase,” the inertial force acting upon the slider is smaller than the frictional force: the slider sticks to the contact surface of the stator and moves along with it. In the opposite direction of the tangential motion, the stator is deactivated faster relative to its initial position. During this time, the “slip phase” or “fast phase”, the inertial force acting upon the slider is greater than the frictional force so that the slider slides on the stator and lags behind the contact surface of the stator element. At the end of a cycle, or within a cycle of the stick and slip phase, the slider takes a microscopic step. The accumulation of these microscopic steps creates the macroscopic motion.

FIG. 1 shows a stator 10 of a piezoelectric inertia motor which comprises an elastic frame 14, a friction tip 12 as a contact, and screws 13 for adjusting the preload and tolerance. As shown in FIG. 1, the stator of an inertia motor can have two actuators 11ab, for example, multilayer actuators 1 and 2 with several superimposed crystal layers, each having capacitances Ca1 and Ca2. As one of the two actuators expands, the other actuator contracts to generate the reciprocating tangential motion illustrated by arrow 15.

FIG. 2 shows a stator 20 of a piezoelectric inertia motor with a single actuator 21 or a multi-layer actuator as a driving source, where like elements have the same designation as in FIG. 1. Only one electronic channel there needs to be connected to the actuator.

FIG. 3 shows a photo of a piezoelectric multilayer actuator. Multilayer actuators in electronic circuits can be understood to be capacitive elements. For clarification, actuators are referred to as “capacitive piezoelectric actuators” in the present specification. In general, they are used according to a capacitor in a low-pass filter.

In an inertia motor with two actuators, two piezoelectric actuators or single-crystal multilayer actuators or bulk actuators in a stator element are driven by two inversely phased (“mirrored”) sawtooth-like signals. In such a structure, the expansion and contraction take place synchronously in opposite directions. As one actor expands, the other actor must contract (or shrink).

A signal applied to the piezoelectric element within a motor typically has a sawtooth shape. A typical idealized sawtooth waveform of a signal for an inertia motor is shown in FIG. 4. During the slow phase, or stick phase, the one actuator slowly expands and the other actuator slowly contracts. A multilayer actuator slowly expanding and contracting corresponds to or is equivalent to slowly charging or discharging a capacitor.

Correspondingly, during the fast phase or slip phase, the one piezoelectric actuator expands rapidly while the other contracts rapidly. Fast expansion or contraction is equivalent to fast charging or discharging of a capacitor. The capacitor there is the capacitance of a multi-layer actuator. In this disclosure, actuators are treated largely like capacitor elements used in filter components of drive circuits.

In FIG. 4, the two waveforms plotted correspond to the control signals for two actuators expanding and contracting in opposite direction in a stator of a piezoelectric inertia motor. For actuators with only one multi-layer actuator, it is sufficient to consider one of the two sawtooth waveforms.

Sawtooth-shaped signal waveforms of the control signals for the actuators can have flattened sections between the slow and the fast phase or at the transition from the slow to the fast phase, respectively. This is shown in an idealized form in FIG. 5.

Simple audio amplifiers cannot drive an inertia motor even if the frequency of the sawtooth signal is in the range of several hundred kHz to 20 kHz. The reason for this is that the fast phase of the sawtooth signal needs to be as short as possible in the 0.5 to 2 μs range, regardless of the operating frequency. When the operating frequency is at around 20 kHz, as is the case with standard audio amplifiers, it is not possible to actuate a fast phase of 0.5 μs. A drive should have at least 1 MHz bandwidth.

### SUMMARY

It is an object of the present invention to provide a method for an efficient drive of piezoelectric inertia motors. The efficiency presently refers to the electrical energy used for the drive and the possibility of miniaturizing drive circuits.

The object is satisfied according to the features of the invention described herein. Some advantageous embodiments are also described.

The invention is based on the idea of using an inductance and an actuator capacitance for actuating a piezoelectric actuator with a sawtooth-like, non-symmetrical voltage waveform. Resistive elements (resistors) are typically used with piezoelectric actuators. The use of inductances instead of resistive elements is made possible by the high-frequency operation of switching elements such as GaN (gallium nitride) transistors.

When inductive elements are used in series with a piezoelectric actuator, a voltage waveform typically has a sinusoidal shape. With the circuit topology proposed, non-symmetrical signal waveforms can be obtained by operating GaN transistors at very high frequencies, even when inductive elements are employed.

A particular approach of the present invention is the adaptation of the class D amplifier topology for the drive of piezoelectric inertia motors in which switching elements such as GaN transistors which can be operated in high frequencies with low on resistance are implemented.

The drive and control methods described in the present disclosure can be applied to piezoelectric inertia motors with two actuators as the drive source as well as with only a single actuator.

During the fast phase, a half-bridge high-frequency circuit of the H-bridge high-frequency circuit charges or discharges the capacitor of a piezoelectric actuator, or in the case of two piezoelectric actuators, two half-bridge (or H-bridge) high-frequency circuits charge and discharge the two capacitors of the actuators in parallel. The actuator capacitance and small inductances, which are operated in resonance, cause fast charging or discharging of the capacitor. The capacitors of the actuators charge according to a step response or discharge according to a natural response of an RLC (resistance-inductance-capacitance) series configuration. Slow charging and discharging takes place by applying high frequency pulse width modulation (PWM) signals, in the case of two actuators synchronous and in the direction opposite to the inputs of a single half-bridge.

Unlike purely resistive elements, the current passing through an inductance during charging or discharging times is stored therein as electrical energy instead of being completely dissipated as heat. This stored energy is used during the subsequent fast discharging or charging period. As a result, the current to be supplied by the source and therefore the dissipated energy in the inductance and in the actuator is reduced. Because GaN transistors can be operated as switching elements at high frequencies (1 to 40 MHz), small inductances suitable for the operation at high frequencies can be used with high efficiency. As a result, a heat sink can be eliminated, which enables the miniaturization of drive circuits.

A wireless control method for driving a piezoelectric inertia motor is furthermore provided. Electromagnetic energy is generated by driving a transmitting coil at a high frequency by switching elements such as GaN transistors. The electromagnetic energy is picked up by a receiving coil (or coils) and converted into current. This current is used to charge or discharge the capacitor(s) of the piezoelectric actuators (or the actuator) and thereby cause the expansion or contraction of the piezoelectric actuators.

According to a first aspect of the present invention, a control device for a piezoelectric inertia motor is provided, the control device comprising: a capacitive piezoelectric actuator, an inductance, a first switching element connecting the capacitive piezoelectric actuator via the inductance to a first potential, a second switching element connecting the capacitive piezoelectric actuator via the inductance to a second potential that differs from the first potential; and a control element which is suitable for repeatedly switching the first switching element and the second switching element with pulse width modulation in directions opposite to one another in a stick phase of the piezoelectric inertia motor, where, in the pulse width modulation, a time component of a first switching state of switching states ON and OFF increases relative to a time component of a second switching state and the pulse width modulation is filtered by the capacitive piezoelectric actuator and the inductance, and thereby carrying out a stepwise first charging operation of charging operations charging and discharging at the capacitive piezoelectric actuator, and reversing the time component of the first switching state and the time component of the second switching state at the beginning of a slip phase of the piezoelectric inertia motor, and thereby carrying out a second charging operation in the direction opposite to the first charging operation at the capacitive piezoelectric actuator.

According to a second aspect of the present invention, a control method for a piezoelectric inertia motor is provided, comprising, in a stick phase of the piezoelectric inertia motor, repeatedly switching in directions opposite to one another a first switching element connecting a capacitive piezoelectric actuator via an inductance to a first potential and a second switching element connecting the capacitive piezoelectric actuator via the inductance to a second potential, with pulse width modulation, where, in the pulse width modulation, a time component of a first switching state of switching states ON and OFF increases relative to a time component of a second switching state and the pulse width modulation is filtered through the capacitive piezoelectric actuator and the inductance, whereby a stepwise first charging operation of charging operations charging and discharging is carried out at the capacitive piezoelectric actuator, and reversing the time component of the first switching state and the time component of the second switching state at the beginning of a slip phase of the piezoelectric inertia motor, whereby a second charging operation in the direction opposite to the first charging operation is carried out at the capacitive piezoelectric actuator.

For example, a damped oscillating circuit containing the capacitive piezoelectric actuator and the inductance can exhibit an overshoot in the transition from the slip phase to the stick phase.

For example, the inductance represents a first inductance, the first switching element connects the capacitive piezoelectric actuator via the first inductance to the first potential, and the device comprises a second inductance, a third switching element connecting the capacitive piezoelectric actuator via the second inductance to the first potential, and a fourth switching element connecting the capacitive piezoelectric actuator via the second inductance to the second potential, where the control element is suitable in the slip phase for switching the third switching element during the first charging operation (of charging and discharging or charging in the direction and in a direction opposite to the direction of polarization of the capacitive piezoelectric actuator) equally to the first switching element and for switching the fourth switching element equally to the second switching element during the second charging operation.

The inductance can represent a first inductance, and the capacitive piezoelectric actuator which is connected via the first inductance to the first switching element and to the second switching element, and the control device can comprise: a third inductance, a fifth switching element connecting the capacitive piezoelectric actuator via the third inductance to the first potential, and a sixth switching element connecting the capacitive piezoelectric actuator via the third inductance to the second potential, where the control element is suitable for switching the fifth switching element equally to the second switching element and the sixth switching element equally to the first switching element.

For example, the inductance represents a receiving inductance, the control device contains a transmitting inductance, and the capacitive piezoelectric actuator is connected inductively via the receiving inductance and the transmitting inductance to the first switching element and the second switching element.

The control device can be configured to carry out the first charging operation and the second charging operation without contact via the transmitting inductance and the receiving inductance.

For example, the capacitive piezoelectric actuator represents a first capacitive piezoelectric actuator, the receiving inductance represents a first receiving inductance, and the control device contains a second receiving inductance and a second capacitive piezoelectric actuator which is connected inductively via the second receiving inductance and the transmitting inductance to the first switching element and the second switching element, and the first piezoelectric actuator and the second piezoelectric actuator are oriented in the opposite polarization direction.

The control device can comprise a transformer containing the transmitting inductance and the receiving inductance.

For example, the capacitive piezoelectric actuator represents a first capacitive piezoelectric actuator, and the control device comprises a second capacitive piezoelectric actuator connected in parallel or in series with the first capacitive piezoelectric actuator in the opposite polarization direction.

For example, the capacitive piezoelectric actuator represents a first capacitive piezoelectric actuator, the inductance represents a first inductance, the control device comprises a second capacitive piezoelectric actuator which is connected by a seventh switching element via the fourth inductance to the first potential and via an eighth switching element to the second potential, and the control element is suitable for switching the seventh switching element in the direction opposite to the first switching element and for switching the eighth switching element in the direction opposite to the second switching element.

For example, a frequency of the pulse width modulation is at least 1 MHz.

The frequency of the pulse width modulation can be higher by a factor of at least 30 than a charging frequency of the capacitive piezoelectric actuator.

For example, the control device comprises gallium nitride transistors as switching elements (the first to eighth switching elements).

The first and the second charging operation can comprise charging operations charging and discharging or charging in the polarization direction of the capacitive piezoelectric actuator and charging in the direction opposite to the polarization direction of the capacitive piezoelectric actuator.

### BRIEF DESCRIPTION OF THE DRAWINGS

Further details, advantages, and features of the invention shall arise from the following specification and the drawings to which reference is expressly made with regard to all details not described in the text, where:

FIG. 1 shows a stator of a piezoelectric inertia motor with two actuators.

FIG. 2 shows a stator of a piezoelectric inertia motor with an actuator.

FIG. 3 shows a piezoelectric multilayer actuator.

FIG. 4 shows an idealized waveform of a signal for a piezoelectric inertia motor.

FIG. 5 shows an idealized waveform of a signal for a piezoelectric inertia motor.

FIG. 6 shows a circuit topology.

FIG. 7 shows switching states of switching elements of a circuit topology for slow charging and fast discharging.

FIG. 8 shows idealized waveforms of signals in opposite directions for two actuators of a piezoelectric inertia motor.

FIG. 9 shows a circuit topology.

FIG. 10 shows switching states of switching elements of a circuit topology for slow charging and fast discharging.

FIGS. 11-14 show a circuit topology.

FIGS. 15-17 show a circuit topology.

FIG. 18 shows a full bridge circuit with capacitive actuators connected in parallel.

FIG. 19 shows a full bridge circuit with capacitive actuators connected in series.

FIG. 20 shows an arrangement with a transformer coupling.

FIGS. 21-23 show arrangements for a contactless drive.

FIGS. 24-25 show measured signal profiles of current and voltage at capacitive piezoelectric actuators.

FIG. 26 shows PWM signals for generating voltage waveforms at capacitive piezoelectric actuators with the idealized waveforms.

FIG. 27 shows a PWM signal for generating a voltage waveform at a fast charging and slow discharging actuator with an experimental waveform.

FIG. 28 shows a PWM signal for generating a voltage waveform at a fast discharging and slow charging actuator with an experimental waveform.

FIG. 29 shows phases of voltage waveforms at capacitive piezoelectric actuators.

FIG. 30 shows a transition period from the slip phase to the stick phase.

FIGS. 31-33 show the dependency of the voltage signal at actuators on the frequency of a pulse width modulation signal.

FIG. 34 shows the circuit diagram of an RLC oscillating circuit.

FIG. 35 shows a circuit topology as an example of an RLC oscillating circuit.

FIG. 36 shows the reading of a resonance frequency of an RLC oscillating circuit from measured voltage and current profiles over time.

FIGS. 37-38 shows a comparison between the measured and modeled current profile.

FIG. 39 shows a configuration of an RLC oscillating circuit during the fast phase with a natural response.

FIG. 40 shows a configuration of an RLC oscillating circuit during the fast phase with a step response.

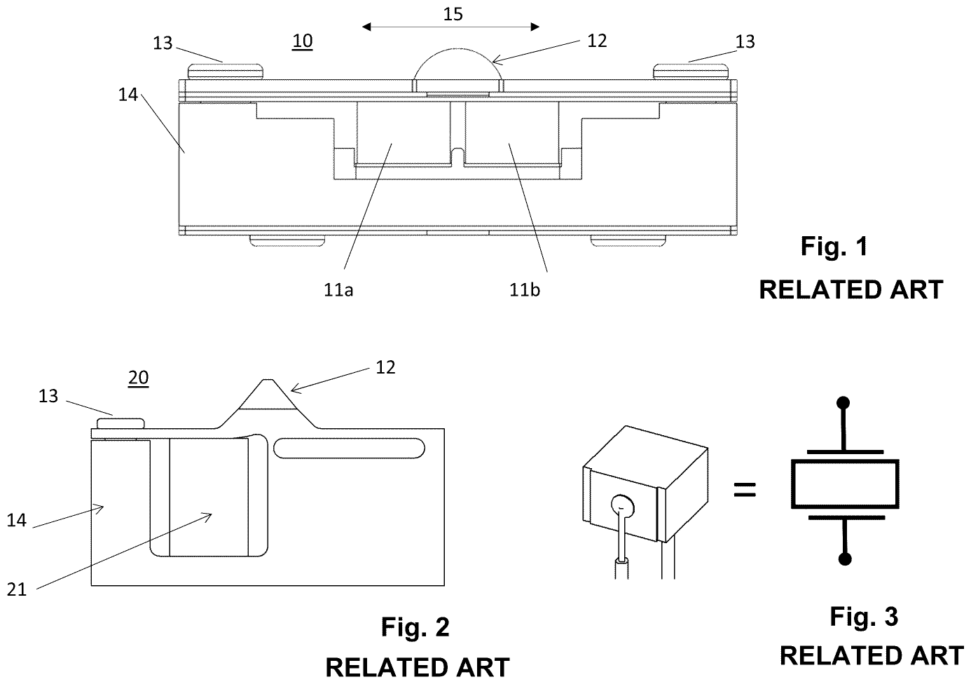

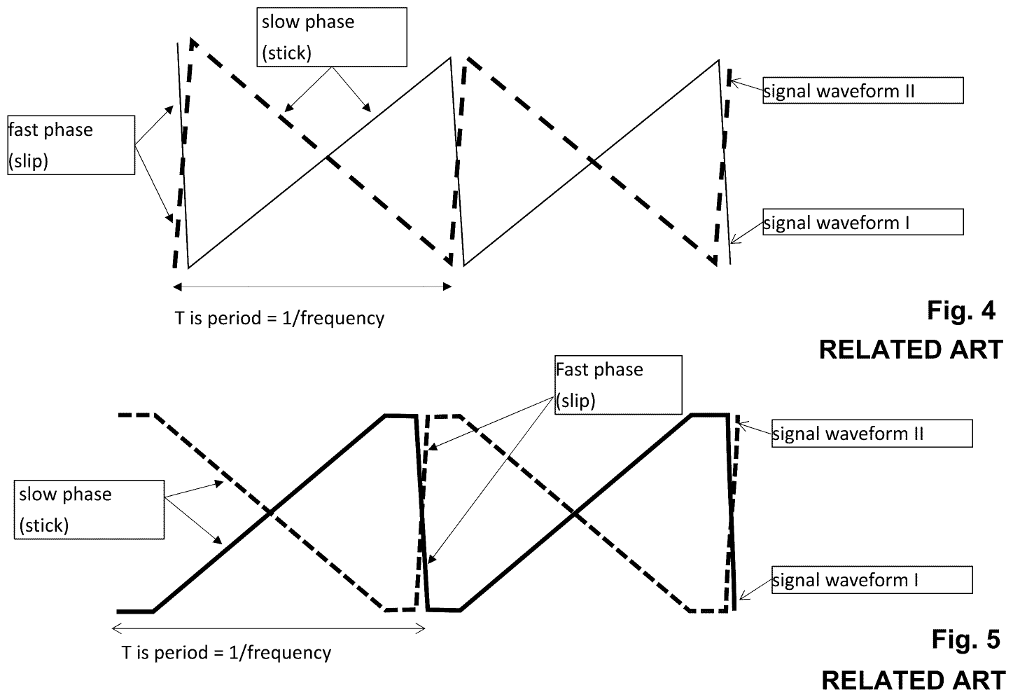

### DETAILED DESCRIPTION

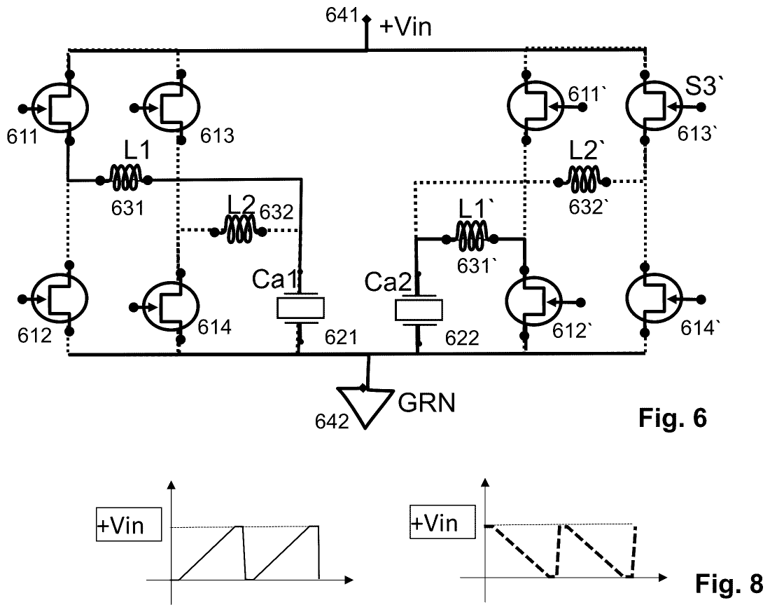

A circuit topology according to an exemplary embodiment is shown in FIG. 6. Only output sections with inductive elements that are connected in series with the actuators can be seen there.

A capacitive piezoelectric actuator 621 is connected via an inductance 631 by a first switching element 611 to a first potential 641 and by a second switching element 612 to a second potential 642.

By way of example, second potential 642 is referred to as ground (GRN). In general, however, it is sufficient for potentials 641 and 642 to differ from one another.

As shown in FIG. 6, in addition to inductance 631, actuator 621 is connected via a further inductance 632 by switching elements 613 and 614 to potentials 641 and 642.

Of the elements shown in FIG. 6, the elements mentioned above are sufficient for actuating a single actuator. However, if a piezoelectric inertia motor is driven by two actuators, then the topology described, as shown in FIG. 6, is connected to a second piezoelectric actuator 622 that is connected by switching elements 611′ and 613′ to first potential 641 and via switching elements 612′ and 614′ to second potential 642.

In the configuration shown in FIG. 6, each actuator is therefore actuated and operated by a dual half-bridge circuit topology.

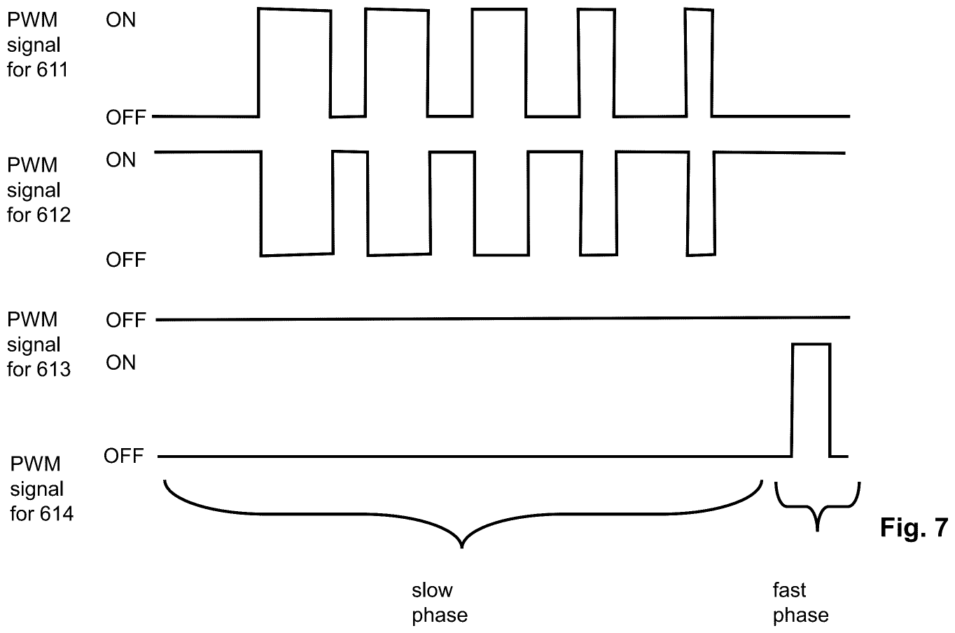

In the slow phase or stick phase, charging or discharging is effected by an inductance, for example, inductance 631. For this purpose, switching elements 611 and 612 are actuated with a suitable pulse width modulation signal which causes switching elements 611 and 612 to open and close synchronously so that slow charging or discharging can take place. Switching elements 611 and 612 are repeatedly switched in directions opposite to one another, as shown schematically in FIG. 7 using the example of slow charging and fast discharging of capacitive actuator 621. While switching element 611 is switched on, switching element 612 is switched off. FIG. 7 schematically shows the switching times and switching durations of the switching elements, where the switching durations, switching times, and synchronization of the switching elements are not to scale and not to be construed to be restrictive in any way.

As can also be seen in FIG. 7, in the pulse width modulation of the slow phase, a time component of a first switching state of ON and OFF increases relative to the respective opposite switching state. At switching element 611, the off pulses are getting longer and longer and the on pulses are accordingly getting shorter and shorter, while at switching element 612, synchronously and in the direction opposite thereto, the on pulses are getting longer and longer and the off pulses are getting shorter and shorter. This increase in the time component of one switching state and the associated decrease in the time component of the other switching state does not occur abruptly, but rather monotonically or continuously during the slow phase.

Averaged over the slow phase, an average time component of the first switching state can be greater than an average time component of the second switching state in order to reach the charge state to be obtained by the charging operation in the slow phase. On average, charging then outweighs discharging when the actuator is being charged in the slow phase, and discharging outweighs charging when the actuator is being discharged.

As can also be seen in FIG. 7, at the end of the slow phase or at the beginning of the slip phase, respectively, the time components of the first switching state and the second switching state are each reversed in order to perform the charging operation respectively in the opposite direction to the charging operation carried out in the slow phase at each capacitive actuator (single actuator 621 or two actuators 621, 622). After having been charged slowly, actuator 621 is rapidly discharged in the slip phase in the example of FIG. 7.

GaN transistors can be used as switching elements 611-614, 611′-614′. As can be understood from FIG. 6, switching elements 611 and 612 should not be switched on at the same time, as should pairs of switching element 613-614, 611′-612′ and 613′-614′. When switching element 611 is switched on and switching element 612 is switched off, inductance 631 and capacitive actuator 621, which are connected to each other in series, are connected to a voltage source which has the potential +Vin, or to which the voltage +Vin is applied. Capacitive actuator 621 charges under this condition. When switching element 611 is switched off and switching element 612 is switched on, actuator 621 and inductance 631 connected in series are connected via switching element 612 to ground (GRN) or, more generally, to second potential 642. Capacitive actuator 621 discharges under this configuration. When both switching elements 611, 613 and switching elements 612, 614 are switched off, the capacitive actuator retains its charge or the voltage/potentials applied thereto, respectively, and no current flows through inductances 631 and 632 denoted by L1 and L2. Although not shown in FIG. 6, an equivalent resistance R can be connected in series with capacitive actuator 621 and inductance 631 (Ca1-L1) as well as to capacitive actuator 621 and inductance 632 (Ca1 -L2) in series, respectively.

In FIG. 6, switching elements 611-614 are used to control the current flowing through inductances 631 and 632 to charge or discharge capacitive piezoelectric actuator 621. In this configuration, switching elements 611 and 612 can be used for slowly charging or discharging actuator 621. If a suitable PWM signal opens and closes switching elements 611 and 622 with a relatively high frequency (1 to 40 MHz) in the slow phase, then the potentials or the voltage, respectively, at actuator 621 can be changed by charging and discharging. If the PWM signal causes the average time period, averaged over the PWM pulses, in which switching element 611 is switched on, to be longer than the average time period that switching element 611 is switched off, then the electrical voltage at actuator 621 increases. The same PWM signal makes the average time that switching element 622 is switched off be longer than its average time that it is switched on.

Switching elements 613 and 614 can additionally be activated or switched during the fast discharging in the fast phase. In order to rapidly discharge capacitive actuator 621, switching elements 612 and 614 can be set together in the ON position for a short period of time (e.g. 0.1 to 6 μs). This is shown in FIG. 7 where switching element 614 is switched ON by a short or narrow pulse. Other discharge switching element 612 is already in the ON position at this point in time, so that during this short pulse in the fast phase, switching elements 612 and 614 are switched on simultaneously. Such a configuration has the effect that inductances 631 and 632 are connected in parallel between capacitive actuator 621 and the ground connection (or connection at second potential 642, respectively). Even if the simultaneous ON duration of switching elements 612 and 614 is short, the discharge duration of capacitive actuator 621 in a natural response of the RLC circuit is short because equivalent inductance L (as a combined inductance of L1//L2) is reduced due to the parallel connection of inductive elements 631 and 632. Because the RLC circuit response is a step response of a second-order underdamped system, overshoot can occur, followed by a cycle of damped oscillation, also known as “ringing”. Fast discharge including overshoot and damped oscillation can be effected within a short duration of 0.1 to 6 μs. The subsequent slow phase with the charging of capacitive actuator 621 by switching elements 611 and 612 is then initiated.

As described, the damped oscillating circuit, which comprises capacitive piezoelectric actuator 621 and inductance 631 and any equivalent resistance R and, in the case of a double half bridge, also inductance 632, exhibits overshooting in the transition from the slip phase to the stick phase. While the inertia motor then transitions from the slip phase to the next stick phase at the end of a cycle, in this transition from sliding to stick phase, the control signal which controls the charging and discharging of capacitive actuator 621 or actuators 621, 622 can have a transition phase which comprises the overshoot and damped oscillation.

Charging and discharging a second capacitive actuator 622, if present, occurs in an identical manner, while the signals are mirrored. FIG. 8 shows idealized voltage waveforms at actuators 621 (left side) and 622 (right side) which exhibit the flattened sawtooth profile of the waveforms from FIG. 5. For mirroring or reversing the signals, switching element 611 is switched or actuated identically to switching element 612′, switching element 612 identically to switching element 611′, switching element 613 identically to switching element 614′, and switching element 614 identically to switching element 613′.

As can also be seen in FIG. 7, switching element 613 need not be actuated during either the slow phase nor the fast phase and can remain in the OFF position throughout the cycle. In general, the switching topology shown in FIG. 6 can also be implemented without switching element 613. However, the presence of four switching elements per actuator allows for the reversibility of the switching operations performed in the slow phase and the fast phase and thereby for the tangential motion of the slider at the stator

Furthermore, unlike what is shown in FIG. 6, the present invention can be implemented with a simple half-bridge for every capacitive actuator, that is to say without inductance 632 and associated switching elements 613 and 614. A second inductance 612 accelerates the fast charging or discharging and furthermore, due to its energy absorption, improves the reduction in energy dissipation.

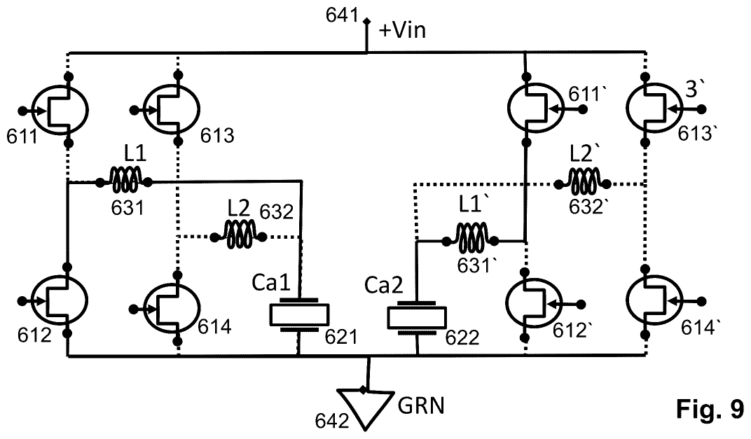

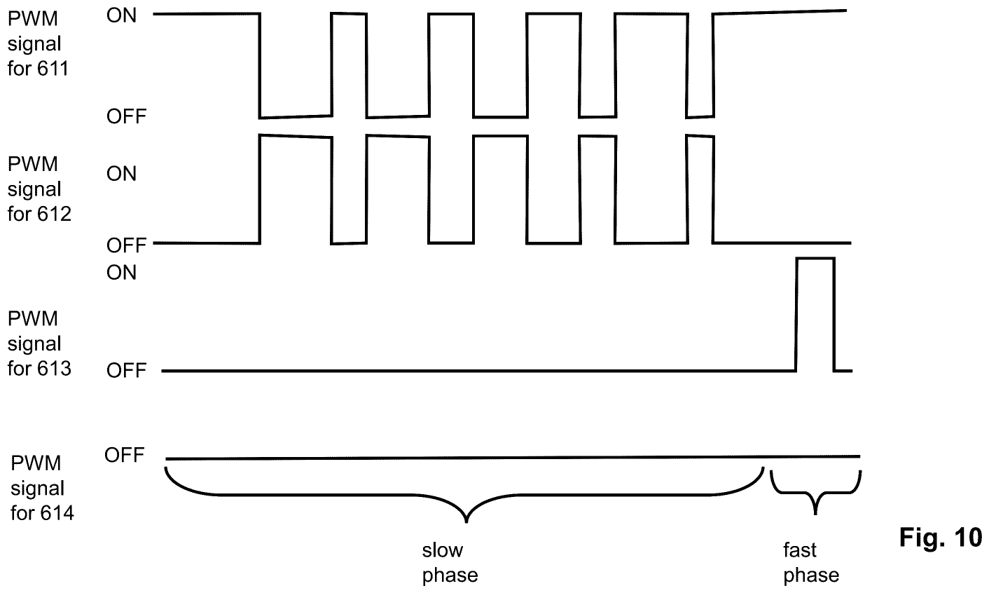

Similarly, the switching elements are switched in the topology shown in FIG. 6 for driving each actuator by two respective half-bridges and two inductances when capacitive actuator 621 is slowly discharged and rapidly charged. When switching element 611 OFF and switching element 612 ON, like in FIG. 9, then capacitive actuator 621 and inductance 631, which are connected in series with each other, are connected to second potential 642 (to ground, GRN). In this state, capacitive actuator 621 discharges. If a suitable PWM signal opens and closes switching elements 611 and 621 in direction opposite to one another at a relatively high frequency (1 to 40 MHz), as shown schematically in FIG. 10, then the potential at capacitive actuator 621 can slowly be discharged.

Switching elements 613 and 614 can be activated or switched, respectively, in parallel with switching elements 611 and 612 for fast charging of capacitive actuator 621 in the fast phase or slip phase to build up a voltage in the range of +Vin. In order to fast charge capacitive actuator 621, switching elements 611 and 613 are set to the ON state for a short period of time (0.1 to 6 μs). This is shown in FIG. 10, where switching element 613 is set to ON by a short or narrow pulse, while other charging switching element 611 is already in the ON state. While switching elements 611 and 613 are in the ON switching state, switching elements 612 and 614 should be in the OFF switching state at the same time. As shown in FIG. 10, switching element 614 therefore need not be activated during fast charging in the fast phase. Like in FIG. 7, the switching times and the synchronization of the switching elements are also shown in FIG. 10 in simplified form and not true to scale.

Even if the duration of the ON switching state for switching elements 611 and 613 is very short in the fast phase, charging the capacitive actuator behaves according to a step response or impulse response of an RLC circuit (taking into account an equivalent resistance R) for the reason that equivalent inductance L is also reduced due to the parallel connection of inductances 631 and 632 (L1//L2). The operating condition presently described with reference to FIGS. 9 and 10 causes capacitive actuator 621 (the capacitive element of capacitance Ca1) to slowly discharge and charge fast, which is equivalent to actuator 621 contracting slowly and expanding rapidly.

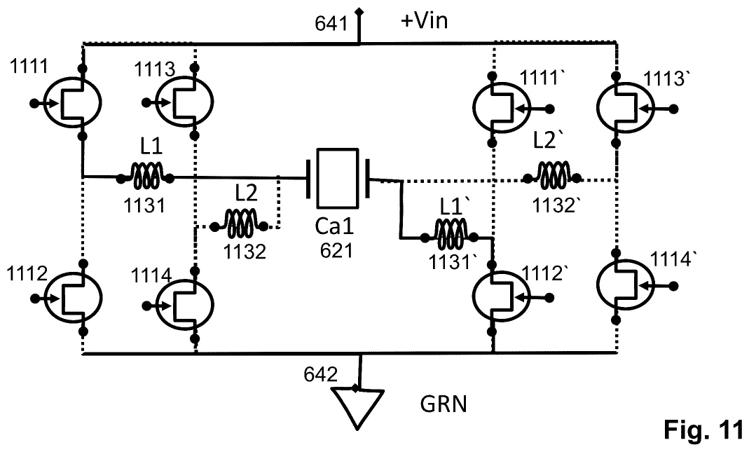

In synchronism with this, capacitive piezoelectric actuator 622 is actuated such that slow charging/expansion and fast discharging/contraction takes place in the former. In particular, the switching conditions are such that switching element 611 is actuated identically to switching element 612′, switching element 612 identically to switching element 611′, switching element 613 identically to switching element 614′, and switching element 614 identically to switching element 613′. Idealized voltage waveforms corresponding to the switching conditions described with reference to FIGS. 9 and 10 are shown in FIG. 11 for capacitive actuator 621 (left side) and for capacitive actuator 622 (right side).

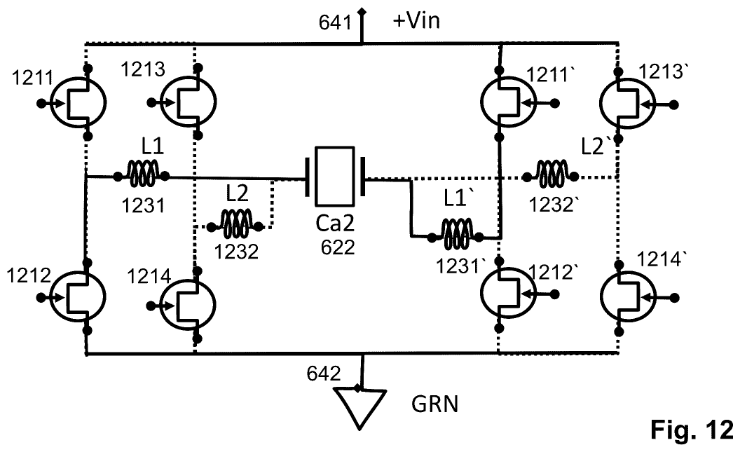

For a further exemplary embodiment, a circuit topology is shown schematically in FIGS. 11 and 12 where there as well only the output sections with inductive elements connected in series with the actuators are shown. In the configuration shown, each actuator (a single actuator 621 or two actuators 621 and 622) is driven by two full-bridge switching topologies (or H-bridge switching topologies), where also only a single H-bridge topology is possible.

As shown in FIG. 11, capacitive actuator 621 is connected in series by switching element 1111 via inductance 1131 to first potential 641 and by switching element 1112′ via inductance 1131′ to second potential 642. By way of a further connection, switching element 1112 connects actuator 621 via inductance 1131 to second potential 642, and switching element 1111′ connects actuator 621 via inductance 1131′ to the first potential in series.

In addition, as shown in FIG. 11, the topology can include an inductance 1132 via which actuator 621 is connected by switching element 1113 to the first potential and by switching element 1114 to the second potential, as well as an inductance 1132 via which actuator 621 is connected via switching element 1113′ to the first potential and via switching element 1114′ to the second potential.

If, in addition to actuator 621, a second actuator 622 is present for driving the piezoelectric motor, then, as shown in FIG. 12, the latter is connected in correspondence to the topology for actuator 621 via inductances 1231, 1232, 1231′ and 1232′ by switching elements 1211-1214 and 1211-1214′ to potentials 641 and 642, respectively.

In this configuration, instead of charging or discharging a capacitor, one can also speak of charging an actuator with a positive or negative potential (or bringing about a positive or negative voltage at the actuator). Charging a capacitive piezoelectric actuator can generate an electric field in the actuator. If, after charging, the electric field is oriented in the same direction as the polarization direction of the piezoelectric actuator, then the capacitance of the actuator (or the capacitor that the actuator acts as in the circuit) can be said to be “positively charged”. If, after charging, the electric field is charged in the direction opposite to the polarization direction of the piezoelectric actuator, then the capacitance of the actuator can be said to be negatively charged. While a positively charged or positively charging actuator expands, a negatively charged or negatively charging actuator contracts.

Capacitance or capacitor 621 can be charged slowly to a positive potential by simultaneously switching switching elements 1111 and 1112 via inductances 1131 and 1131′ with PWM signals, where switching elements 1111′ and 1112 during the slow phase, as previously described for switching elements 511 and 612 with reference to FIG. 7, are repeatedly switched in the direction opposite to switching elements 1111 and 1112. Once the potential or the charge of the actuator has reached a certain value, switching elements 1112, 1114, 1111′ and 1113′ are switched in a narrow pulse simultaneously to the switching state ON, and actuator 621 is charged fast in the fast phase to a negative potential. Such actuation produces a slow expansion in the stick phase and rapid contraction in the slip phase. At the same time, a second actuator 622, as shown in FIG. 12, can be actuated by switching switching elements 1211-1214 and 1211′-1214′ in the direction opposite to switching elements 1111-1114 and 1111′-1114′ for contraction in the stick phase and expansion in the slip phase.

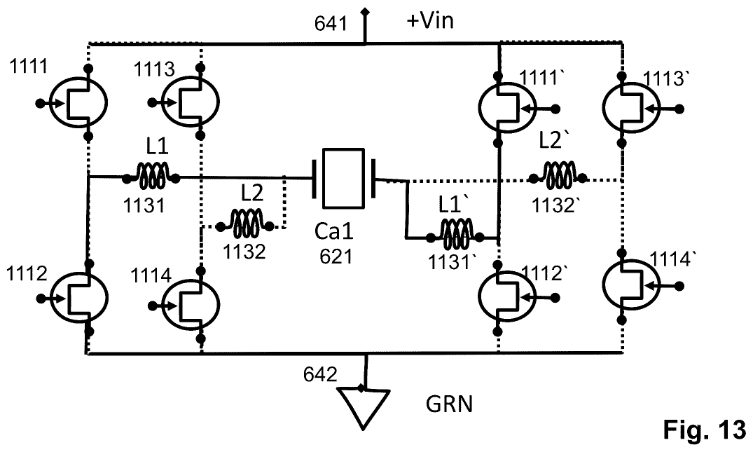

In order to produce a slow contraction at actuator 621 in the stick phase and rapid extension or expansion in the slip phase, actuator 621 is slowly charged to a negative potential, as shown in FIG. 13. This can be done with switching elements 1111′ and 1112 by inductances 1131 and 1131′ using a suitable PWM signal. Once the potential at actuator 621 has reached a certain negative value, the capacitance of actuator 621 is switched by all inductances 1131, 1132, 1131′ and 1132′ and switching elements 1111, 1113, 1112′ and 1114′ shown with a narrow pulse in the ON state to a positive potential.

Similarly, a waveform of the charge signal that is mirrored with respect to actuator 621 is generated at second actuator 622. The capacitance of actuator 622 can be slowly charged to a positive potential with a PWM signal by switching elements 1211 and 1212′ and inductances 1231 and 1231. Once the potential at actuator 622 has reached a certain value, it is charged to a negative potential by a narrow pulse of switching elements 1211, 1214, 1211′ and 1213. Such actuation produces a slow expansion and fast contraction of actuator 622.

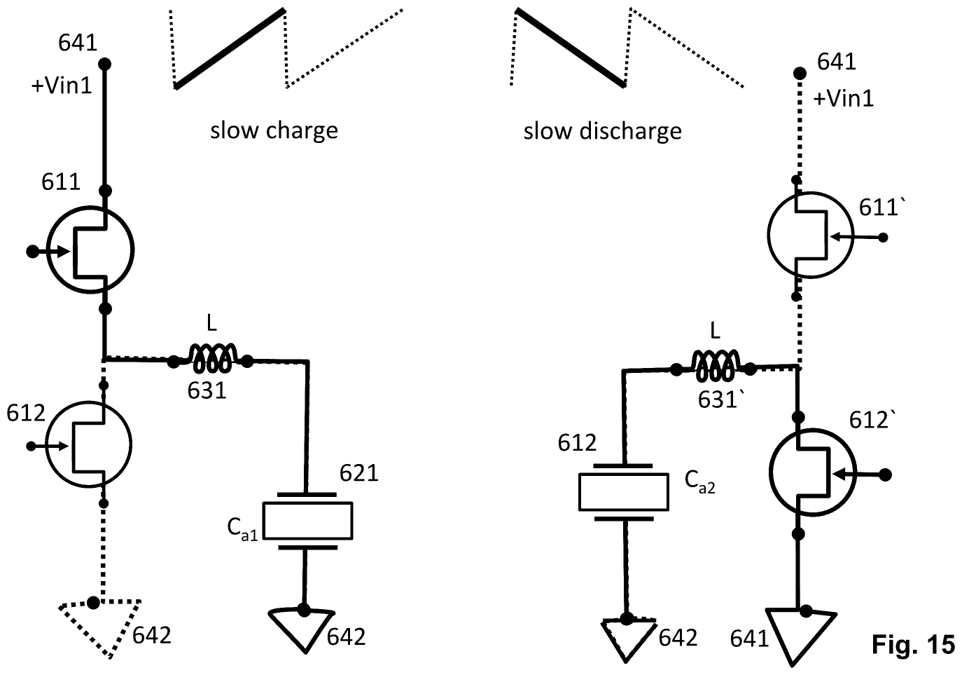

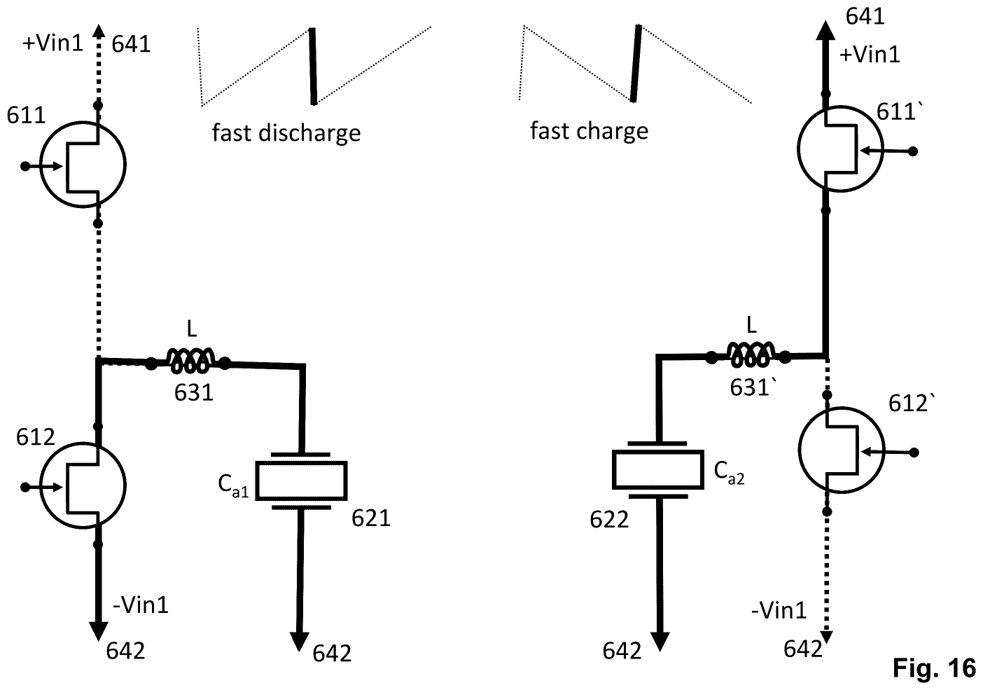

According to an embodiment shown in FIGS. 15 and 16, each actuator is actuated with a simple half-bridge circuit topology. As can be seen in the figures, a respective second inductance and the switching elements connected thereto are missing in comparison to the double half-bridge shown in FIG. 6.

In the case of two actuators 621 and 622 in the configuration shown in FIG. 15, switching element 611 connecting actuator 621 via inductance 631 to first potential 641 is synchronized with switching element 612 ‘connecting actuator 622 via inductance 631’ to second potential 642. In the stick phase, two switching elements 611 and 622′ are actuated by the PMW signal such that both switching elements are ON and OFF at the same time. Ca1 and Ca2 are the capacitances of two actuators 621 and 622. In the ON state of each PWM signal for switching elements 611 and 612′, capacitive actuator 621 charges because it is connected to first potential 541 of source voltage +Vin1, and Ca2 discharges because it is connected to the second potential (e.g. ground as shown in FIG. 15). The ON-state current path of switching elements 611 and 612′ during a PWM pulse is illustrated as a solid line in FIG. 15.

Fast charging or discharging takes place at the end of each cycle of the PWM signal. For the fast phase or slip phase, the current path of the actuating signals is shown in FIG. 16. As an example of the second potential, the value −Vin1 is presently given as an alternative to ground. As already mentioned, the present invention is not restricted to ground or a reciprocal value of the first potential with regard to a value for the second potential, other negative or positive values differing from first potential 641 (e.g. smaller than the first potential) are also possible.

Although the slow rise and drop of the voltage at the capacitive actuators is shown to be linear in an idealized or simplified manner in the schematic voltage profiles shown in FIG. 15, for example, a parabolic rise or drop can be produced by adjusting the PWM signals. The use of GaN transistors as switching elements allows for the PWM frequency to be significantly higher than the resonance frequency of the RLC circuit comprising the respective actuator and inductance. For example, the operating frequency of the PWM signal can be 1 to 40 MHz when GaN transistors are operated at high frequency.

In the configuration shown in FIG. 16, switching element 612 is switched on for a short period of time in the fast phase, and switching element 611 is OFF. The capacitor of actuator 621 (e.g. the multi-layer actuator) discharges rapidly. Discharging takes place according to a natural response of an RLC circuit. Since inductance 631 [sic] actuator capacitance Ca1 of actuator 621 together have a small inductance (e.g. 1 to 10 μH) and capacitance (e.g. 50 to 100 nF), the natural frequency of the RLC circuit (e.g. 200 kHz to 500 kHz) is relatively high compared to the operating frequency of the motor (the sawtooth signal from the stick and slip phase). As a result, the (fast) discharge lasts only about 0.5 to 2 μs. After 4 to 6 μs, the next slow phase begins with the corresponding PWM signal. The frequency of the PWM signal is greater than 1 MHz.

Accordingly, switching element 611′ is switched on for a short period of time and switching element 612′ is switched off. The (fast) charging of actuator 622 behaves according to a step response of an RLC circuit. Due to the small inductance and capacitance values of inductance 631′ or actuator 622, respectively, the actuator reaches an overshoot value within approx. 1 to 2 μs. After a small, heavily damped oscillation, the subsequent (slow) discharge period takes place.

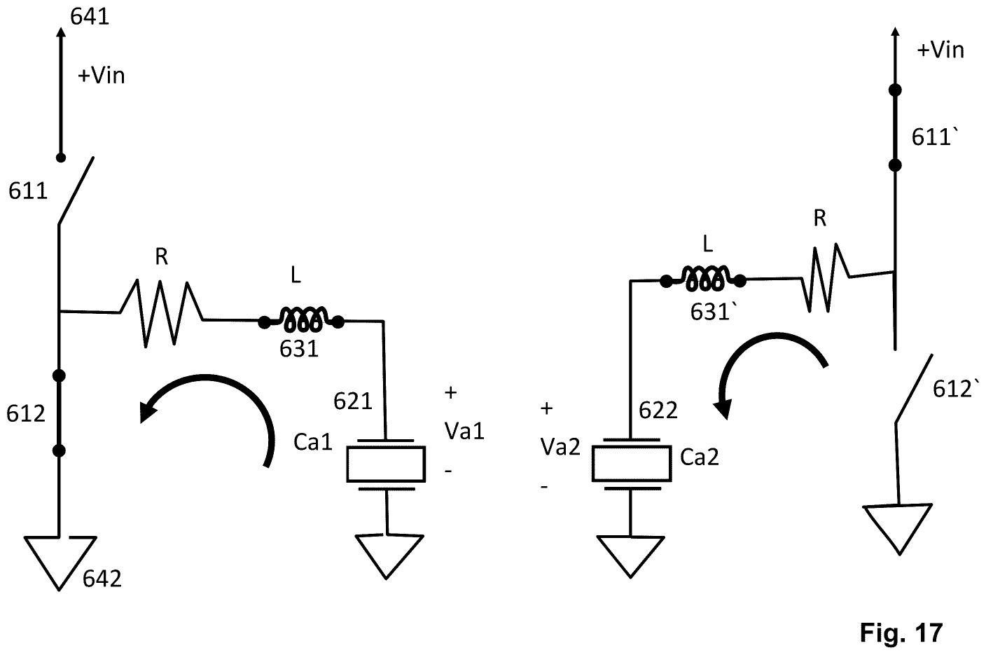

The current path for the fast phase of the drive signals according to a simple half-bridge topology is also illustrated in FIG. 17 by way of open and closed switching elements, where the respective resistance R of the RLC circuit is presently also shown.

In a state where actuator 621 is connected via switching element 612 to capacitance Ca1, inductance 631 and resistor R to second potential 642, capacitive actuator 621 discharges. At the same time, capacitive actuator 622 is connected via resistor R as well as inductance 631′ and switching element 611′ to the first potential of the source voltage +Vin and charges under this condition.

As already mentioned, switching elements 611 and 612′ are ON or OFF at the same time. Switching elements 612 and 611′ are likewise switched ON or OFF at the same time. Resistance R in FIG. 17 corresponds to the total equivalent of the resistance of switching elements, connections, and losses at the inductance and at the capacitance.

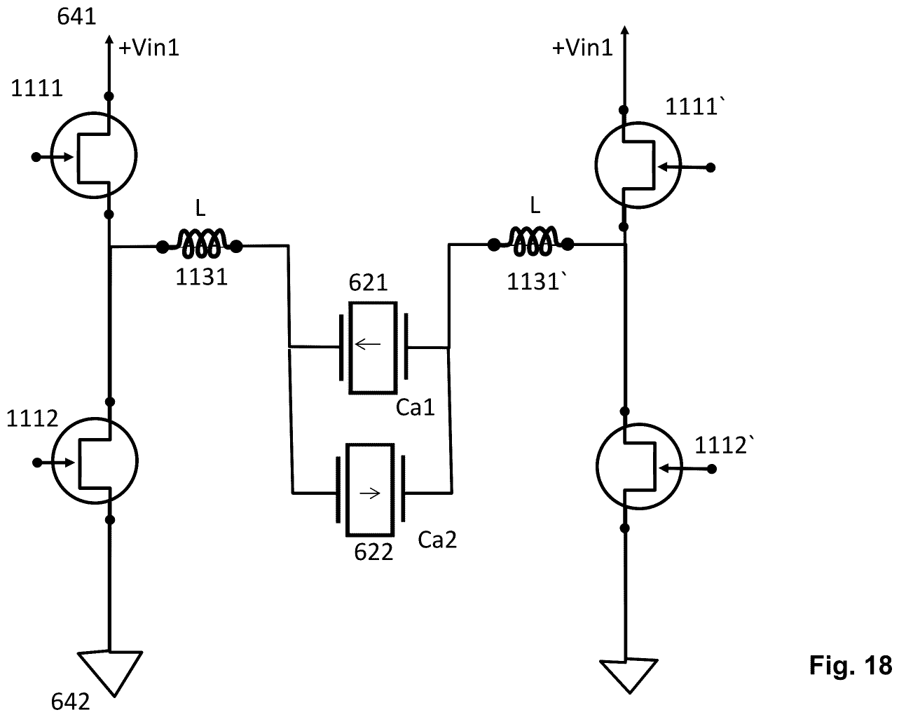

A further exemplary embodiment is shown in FIG. 18. Since the two half-bridges have been combined there, i.e. connected, the circuit there is a full-bridge configuration. Two capacitive piezoelectric actuators 511 and 612 are connected in parallel, and both are connected by switching elements 1111 and 1111 via inductances 1131 and 1131′ to the first potential as well as by switching elements 1112 and 1112′ to the second potential. Both actuators 611 and 612 actuated in parallel are charged by a current path along switching elements 1111 and 1112 or by a current path along switching elements 1112 and 1111′.

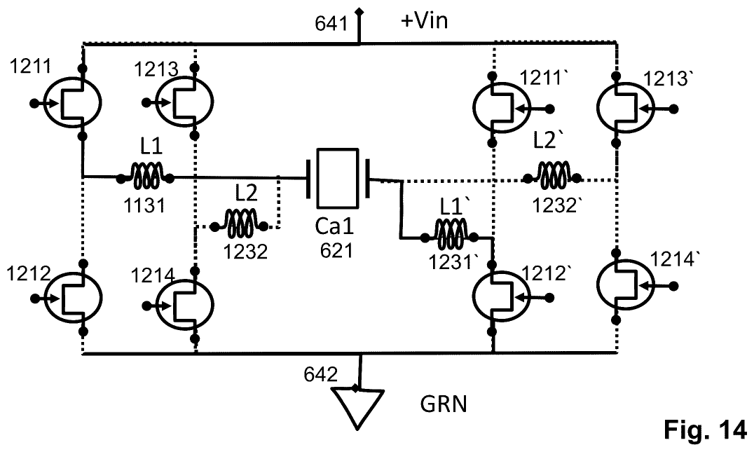

As in the case with the topology described with reference to FIGS. 11 to 14, the two charging operations in the opposite direction can there as well also correspond to charging with respectively opposite polarity or polarization. Due to the mutually opposite polarization directions of piezoelectric actuators 611 and 612, expansion and contraction in each phase (stick phase and slip phase) take place in directions opposite to one another, i.e. one of the two actuators contracts while the other expands.

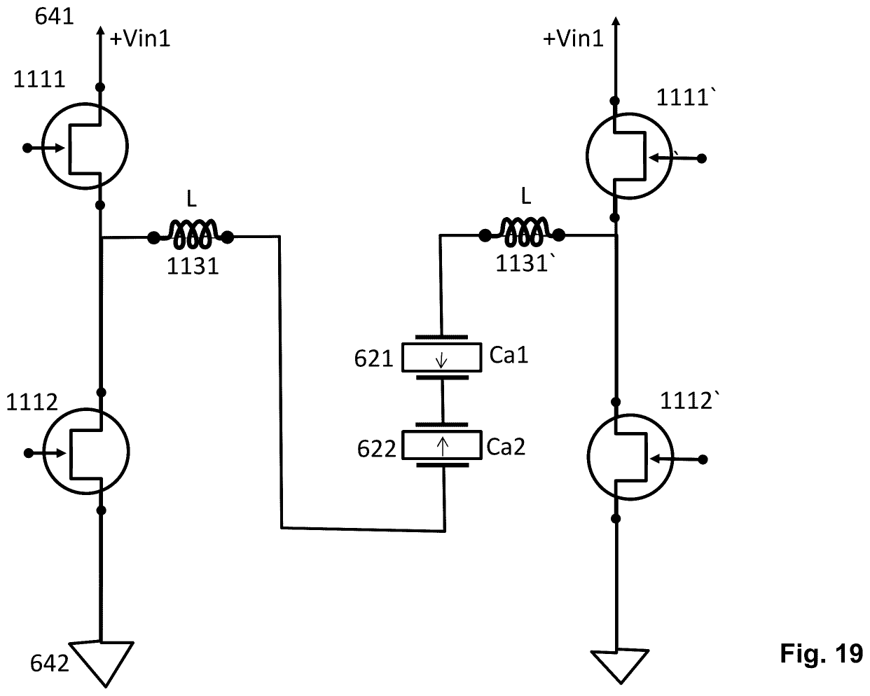

A further embodiment with a full bridge arrangement is shown in FIG. 19. This arrangement differs from that shown in FIG. 18 in that two piezoelectric actuators 621 and 622 are connected in series with one another. They are actuated simultaneously by switching elements 1111 and 1112′ or 1111′ and 1112. Inductances 1131 and 1131′ are connected in series with both actuators. The polarization directions of the two actuators are arranged to be opposite to each other and the charging operations are reverse polarity charging. In this configuration, one actuator contracts while the other actuator expands. Since the two actuators are connected in series, the total capacitance of the drive electronics corresponds to roughly half of one of capacitances Ca1 and Ca2.

In some further embodiments, capacitive piezoelectric actuator 621 or two actuators 621 and 622, respectively, is/are connected inductively via a receiving inductance and a transmitting inductance to two potentials 641 and 642. The transmitting inductance is connected via switching elements 1111 and 1111′ or 1112 and 1112′, respectively, to two potentials 641 and 642, and the receiving inductance is connected to at least one of two actuators 621 and 622. The transmitting inductance transmits electrical energy to the receiving inductance.

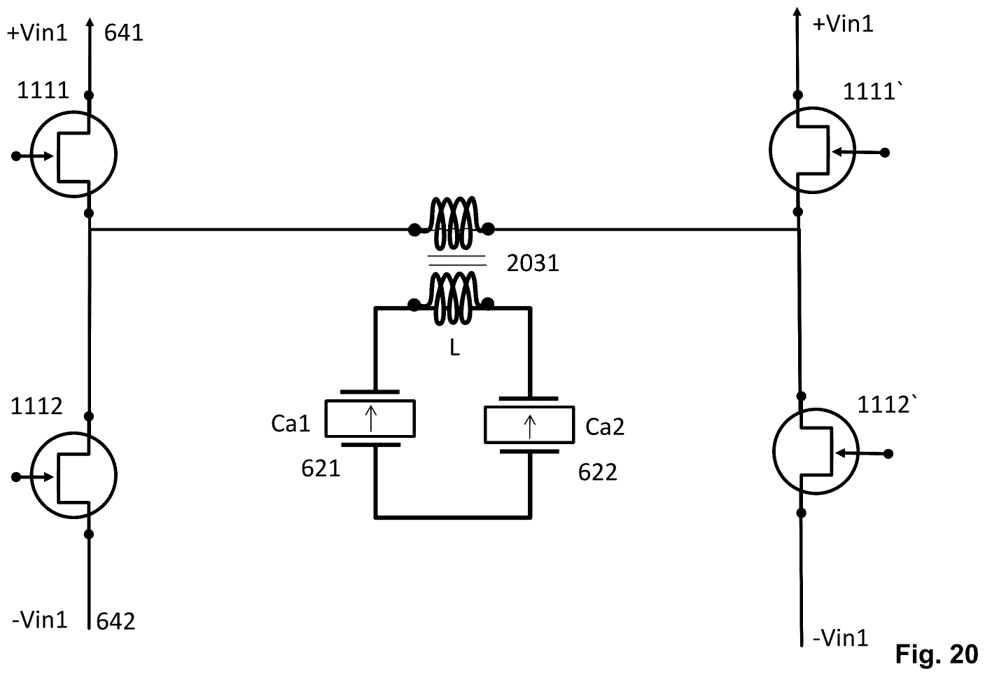

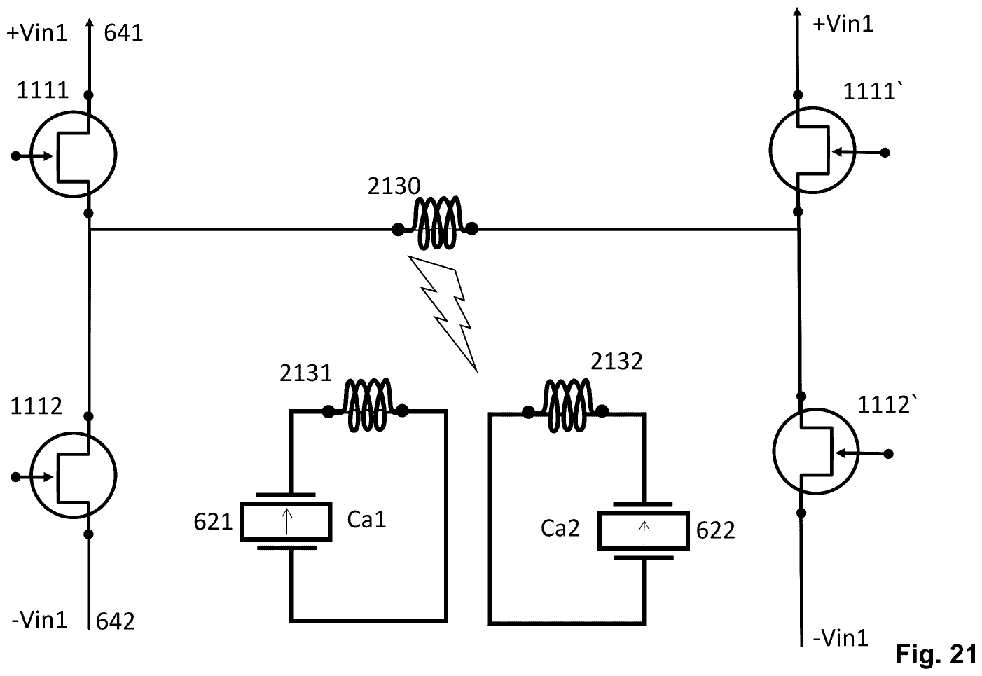

In one embodiment, the receiving inductance and the transmitting inductance are included in a transformer as an input coil and an output coil, respectively. A transformer element can increase or decrease the magnitude of the control signal for the actuators. As shown in Figure a transformer 2031 at the output portion of an H-bridge circuit topology is connected via switching elements 1111 and 1111′, and 1112 and 1112′, respectively, to first potential 641 and second potential 642, respectively. Although the output signal of a transformer is generally sinusoidal, sawtooth-like signals such as signals that approximate a sawtooth or flattened sawtooth can be generated at the piezoelectric actuators by switching at very high frequencies, as can be done, for example, by using GaN transistors as switching elements. The output coil or receiving coil of transformer 2031 also functions as an inductance that is connected to the capacitances of the piezoelectric actuators. As shown in FIG. 20, two actuators 621 and 622 are connected in series (with opposite polarization directions). Alternatively, a parallel connection is also possible, or a single actuator connected to the output coil of transformer 2031.

FIGS. 21 to 23 show further embodiments in which the first charging operation and the second charging operation can take place without contact via a transmitting inductance and a receiving inductance or receiving inductances.

As shown in FIG. 21, the inductive element is replaced by coils for inductive wireless energy transmission, a transmitting coil 2130 and two receiving coils 2031 and 2032. Due to the high-frequency operation of GaN transistors as switching elements 1211, 1211, 1112 and 1112, transmitting coil 2130 (or transmitting inductance) is operated at its operating frequency. A PWM signal generates the energy to be transmitted to the receiving coils (or inductances) 2131 and 2132 such that it is varied like an (approximated) sawtooth signal or sawtooth-like waveform.

Receiving coils 2131 and 2132 can absorb the wirelessly or contactlessly transmitted energy and convert it into a current that flows through them with a high signal frequency. Since the inductance of the receiving coil and the capacitance of the actuator each function as an RLC circuit, the voltage waveform or a voltage drop, respectively, at the actuator capacitance corresponds to a sawtooth-like signal.

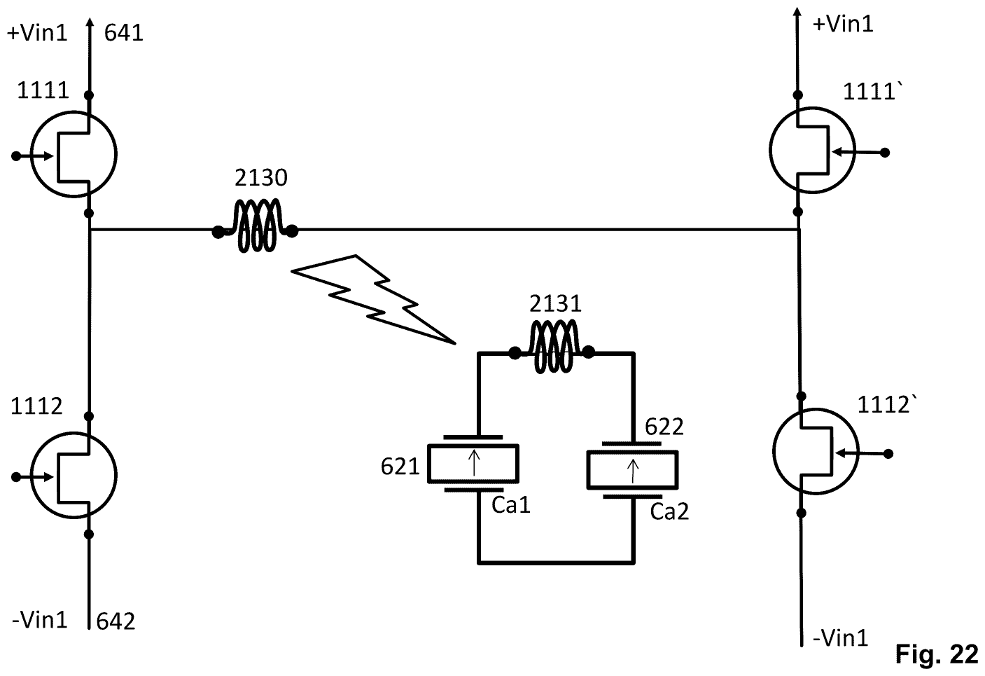

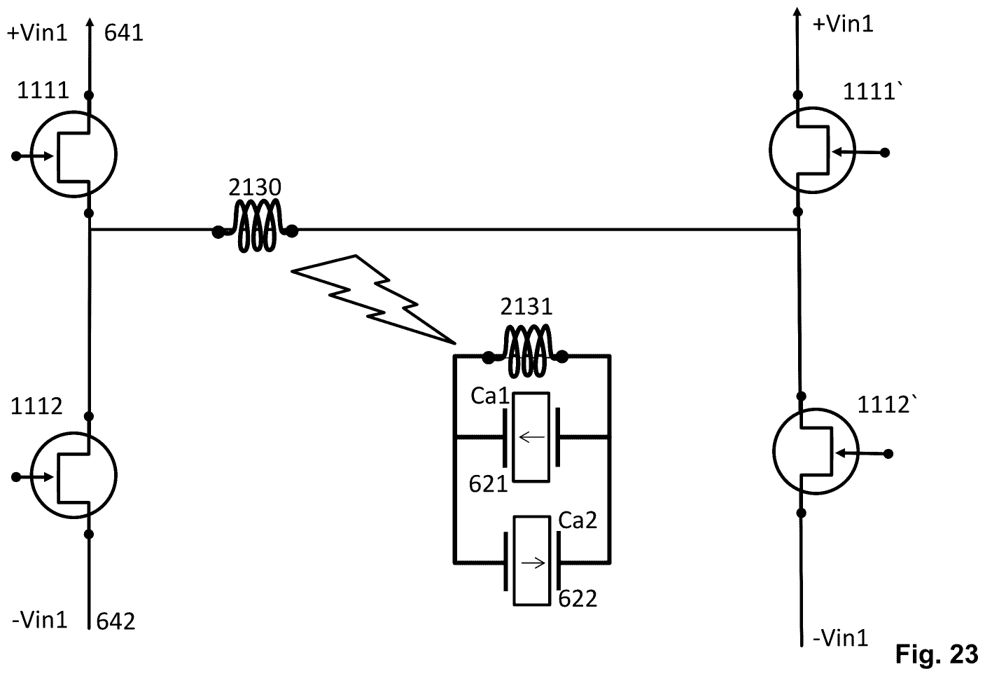

In the embodiments illustrated in FIGS. 22 and 23, the inductive element is respectively replaced by a pair of transmitting coil 2130 and receiving coil 2031. As in the example of FIG. 21, transmitting coil 2130 is operated at its operating frequency by the high-frequency operation of the GaN transistors used as switching elements, and a PWM signal generates the transmitting energy as a sawtooth-like varying waveform.

The receiving coil absorbs the energy from the transmitting coil and supplies it to actuators 621 and 622. Actuators 621 and 622 can either be connected in series, as shown in FIG. 22, or in parallel, as in FIG. 23. In both cases, the polarization directions of the piezoelectric actuators are arranged in direction opposite to one another. As a result, the voltage generated at receiving coil 2131 causes one actuator to expand while the other actuator contracts when current is passed through them.

The present invention provides a control device for a piezoelectric inertia motor. In addition to one or more capacitive piezoelectric actuators and inductances and the switching elements that are interconnected according to the topologies described in this disclosure, this control device also comprises a control element that is suitable for controlling the switching elements of the control device in the stick phase and in the slip phase in order to generate at the actuator or actuators, respectively, the voltage signal waveforms which cause the charging operations in opposite directions in the stick phase and in the slip phase of the piezoelectric inertia motor and thus the expansion and contraction. This control element can be included in the control device, for example, in the form of an integrated circuit which generates the PWM signals as digital signals and/or a computer interface which receives the digital signals.

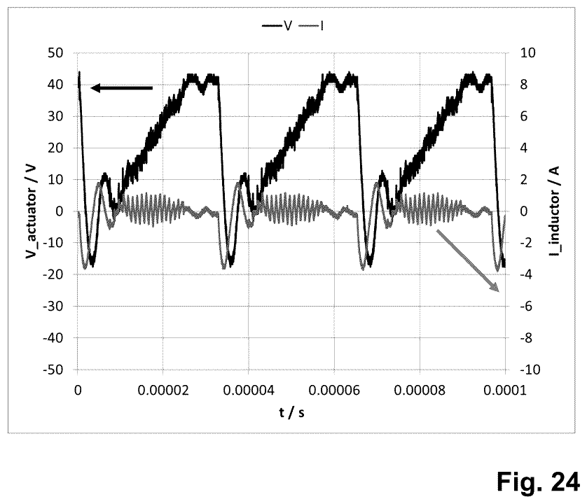

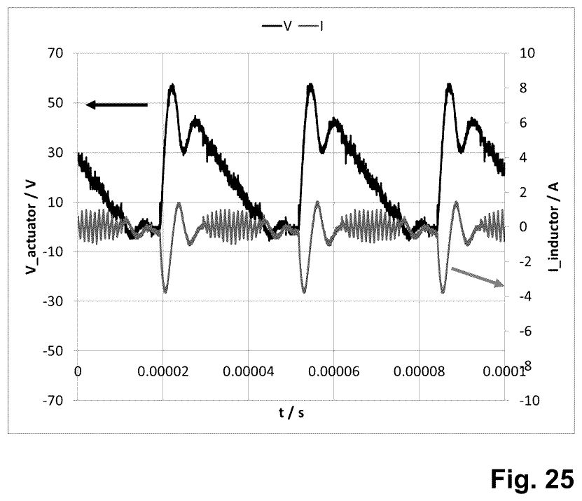

FIGS. 24 and 25 show measured voltage and current waveforms at multilayer actuators. FIG. 24 shows how actuator capacitance Ca1 of a first actuator 621 in the stick phase charges slowly after each fast phase (slip phase). As a natural response of an RLC circuit, the voltage there drops from about 40 volts to about −18 volts. After one cycle of damped oscillation, the PWM signal starts to slowly recharge the actuator. The charging of the capacitance of the multilayer actuator is clearly visible in the waveform of the current.

The measured voltage and current waveforms in the opposite direction are shown for multilayer actuator 622 with actuator capacitance Ca2 in FIG. 25 (the times in FIGS. 24 and 25 are not synchronized). As a result of a fast opening of the charge switching element 612′, the actuator voltage reaches an overshoot at a value of 58 V within 2 μs. Fast charging can take place according to a step response of an RLC oscillating circuit. R comprises the total equivalent resistance Rₒₙ of the switching elements (GaN transistors) and equivalent resistances of the inductance and of the capacitive actuator. After a cycle of a damped oscillation, the PWM signal starts to slowly discharge the actuator as the voltage profile decreases. The discharging of the multilayer actuator capacitance is there clearly visible in the waveform of the current.

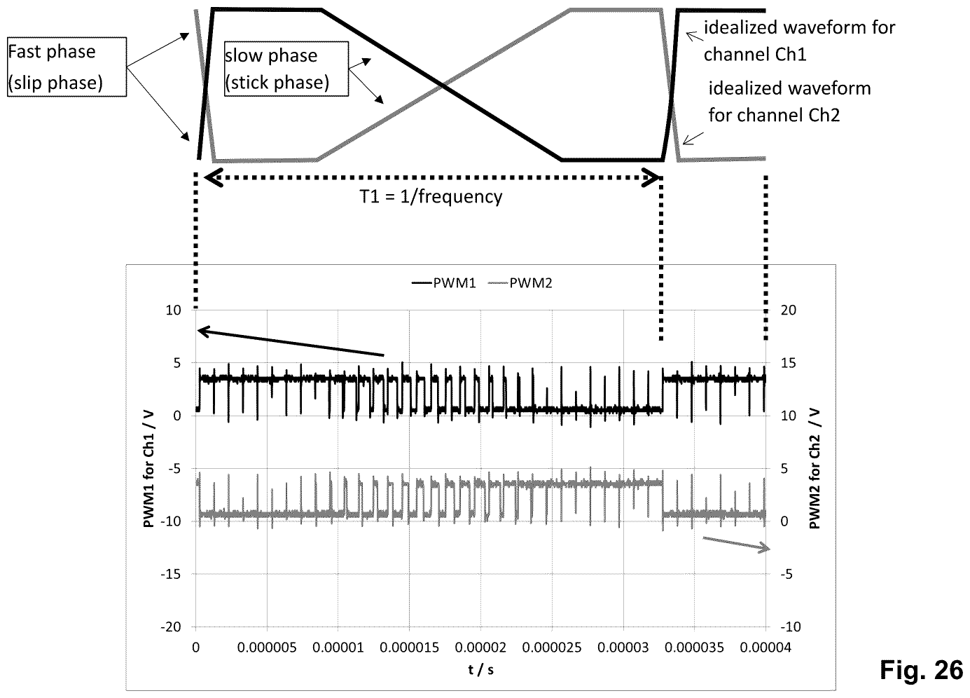

In FIG. 26, PWM signals of two channels Ch1 and Ch2 are shown for actuating a dual-channel inertia motor to generate the desired voltage waveforms at the actuator capacitances Ca1 and Ca2 of two actuators of a piezoelectric inertia motor. T1=1/frequency is the period of the waveform there, with the frequency of the sawtooth-like signal, which is illustrated in FIG. 26 in idealized form. The frequency can be, for example, between 100 Hz and 40 kHz (in the example shown in FIG. 26 with a period of approx. 33 μs at 30 kHz).

In order to generate the modified sawtooth waveforms, PWM signals are first generated in digital form with a high frequency (e.g. 0.5 to 5 MHz). The PWM signals are amplified by GaN transistor switching elements and amplified by the RLC circuit to obtain the final shape of modified sawtooth-like waveforms as voltage profiles for actuating and driving the piezoelectric actuators.

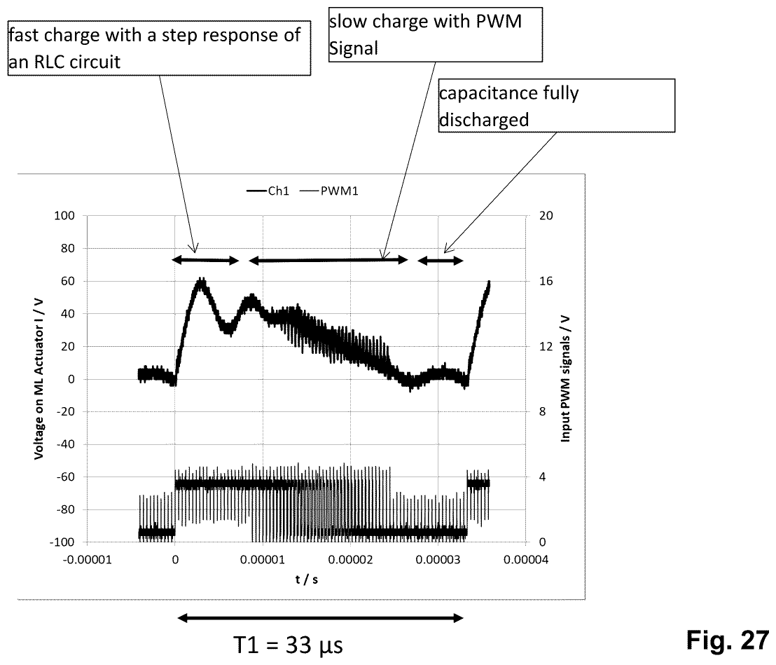

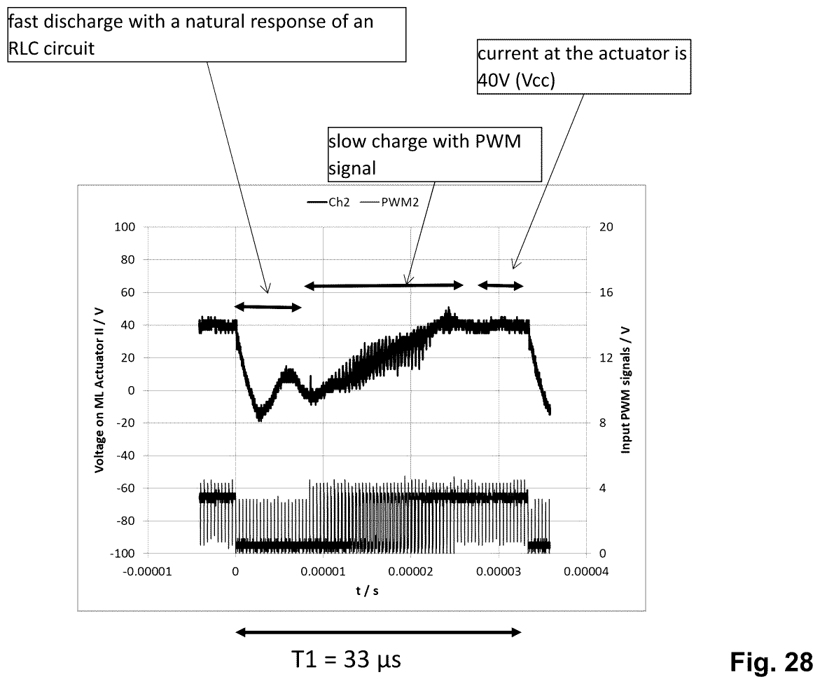

While the waveforms of the voltage profiles at the actuators in FIG. 26 are shown in an idealized form, FIGS. 27 and 28 show the PWM signals in connection with experimentally generated waveforms of the voltage profiles at the actuators. Period T1 of the sawtooth-like (asymmetric) voltage signal is 33 μs (corresponds to 30 kHz), and period T2 of the PWM signal is 0.4 μs (corresponds to 2.5 MHz).

In FIG. 27, a step response of a (serial) RLC circuit connected in series, which is a second-order underdamped system, is shown while fast charging in the fast phase. A damped oscillation (“ringing”) begins, but is quickly dampened and decays. The slow discharge then takes place in the slow phase by the PWM signal (the pulses of the PWM signal can also be seen in the voltage signal at the actuator, but in a filtered form). As can furthermore be seen at the end of the slow phase, the capacitance of the actuator is completely discharged and the voltage at the capacitance (at the actuator) is at 0V, which gives the sawtooth profile of the voltage signal its flattened shape.

As shown in FIG. 28, the fast discharge of the actuator capacitance in the fast phase occurs with a natural response of an RLC circuit connected in series (second-order underdamped system), starting out from a voltage at the capacitance of 40 V. Here as well, a damped oscillation starts that is quickly damped and decays. This is followed by slow charging by the PWM signal in the slow phase until the voltage at the actuator is again at a voltage V_{cc} of 40 V and the profile has flattened out.

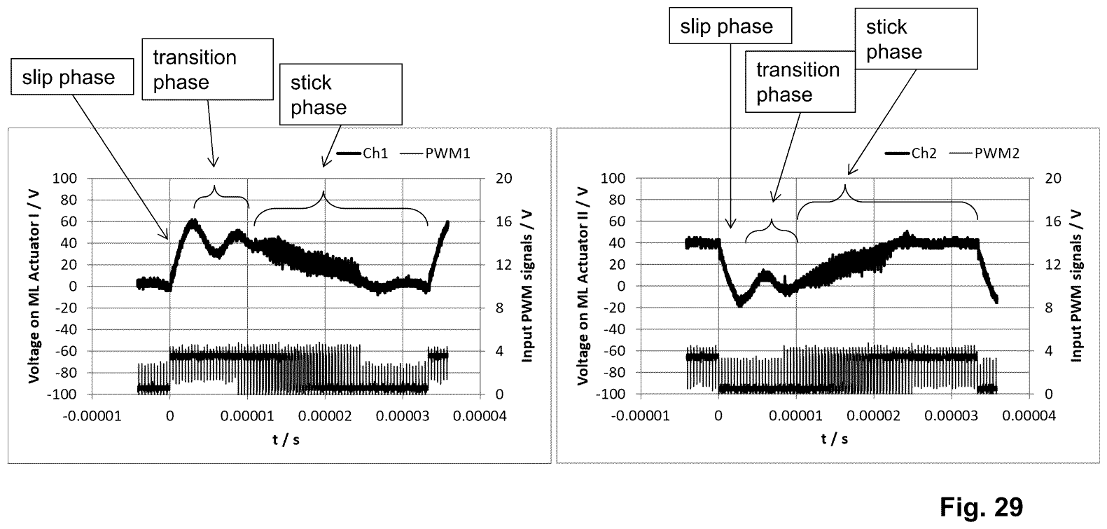

While one distinguishes between a stick phase (slow phase) and a slip phase (fast phase) when driving a piezoelectric inertia motor, the voltage signal at the charging and discharging actuators additionally has a transition phase or transition period at the transition from the slip phase to the stick phase, as already mentioned. This transition phase is characterized by the damped oscillation described that arises in the context of the step response or natural response of the RLC oscillating circuit, as shown in FIG. 29. A transition period exists for both the step response as well as the natural response.

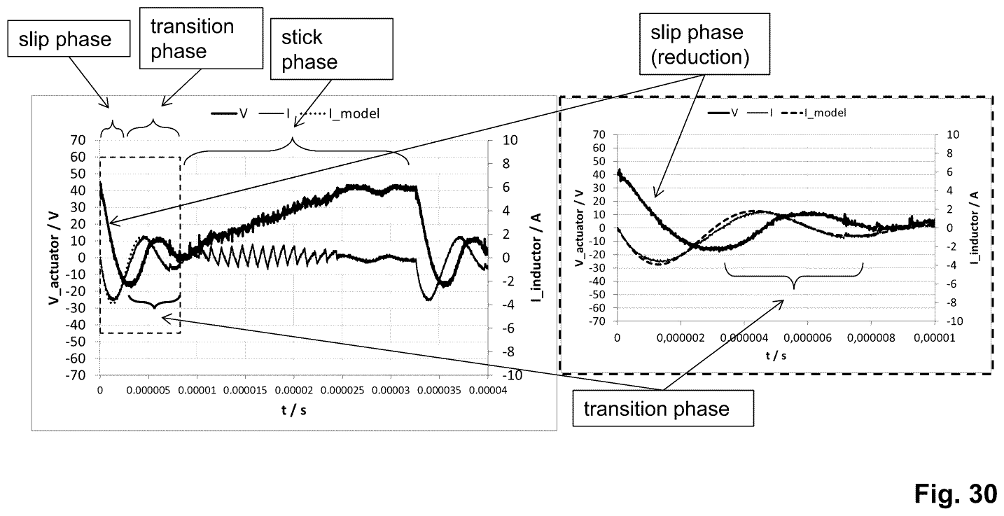

The transition period from the slip phase to the stick phase is also shown in FIG. 30 as an example of a transition from fast discharging to slow charging. The voltage drop during fast discharge (or the increase during fast charge, respectively) can be associated with the fast phase of the voltage signal, and the subsequent damped oscillation to the (short) transition phase between the slip phase and the stick phase. Since two phases (slip phase and stick phases) are generally distinguished when driving the inertia motor, the transition period can be regarded as a separate phase, be associated with the slip phase or the stick phase, or divided between them.

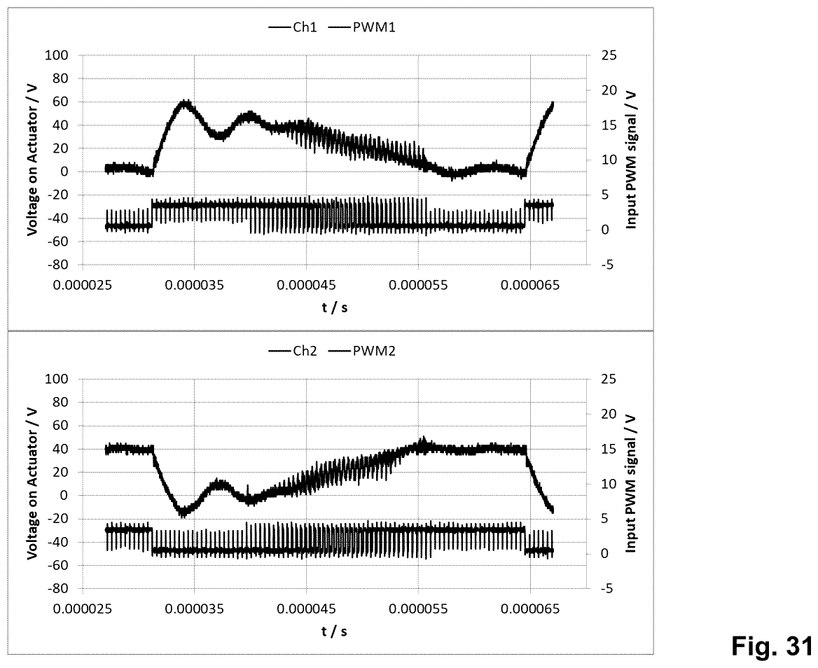

The frequency (f2) of the pulse width modulation is advantageously at least 1 MHz. In addition, it is advantageously higher by a factor of 30 than a charging frequency of the capacitive piezoelectric actuator, i.e. the frequency of the voltage signal that corresponds to period T1 of the voltage signal. The effect of the PWM frequency on the slow phase (stick phase) of the sawtooth-like signal at the actuators is shown in FIGS. 31-33.

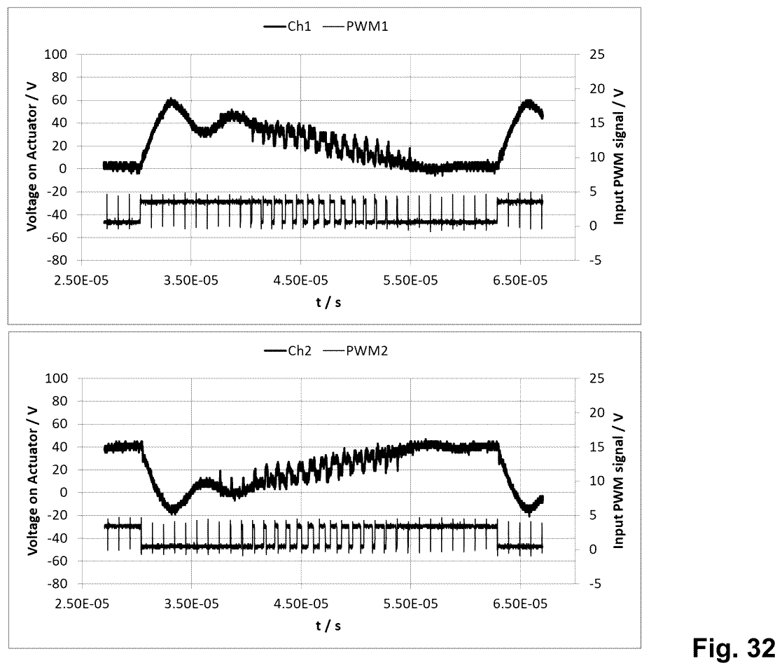

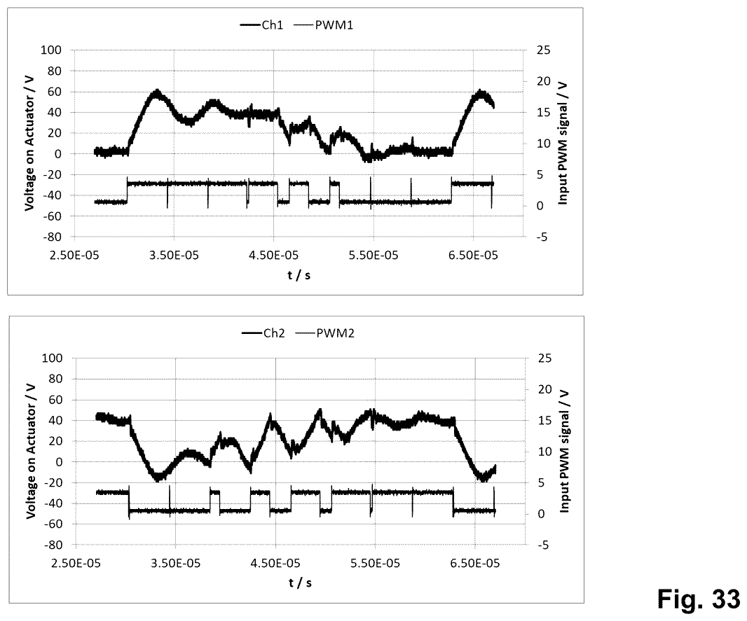

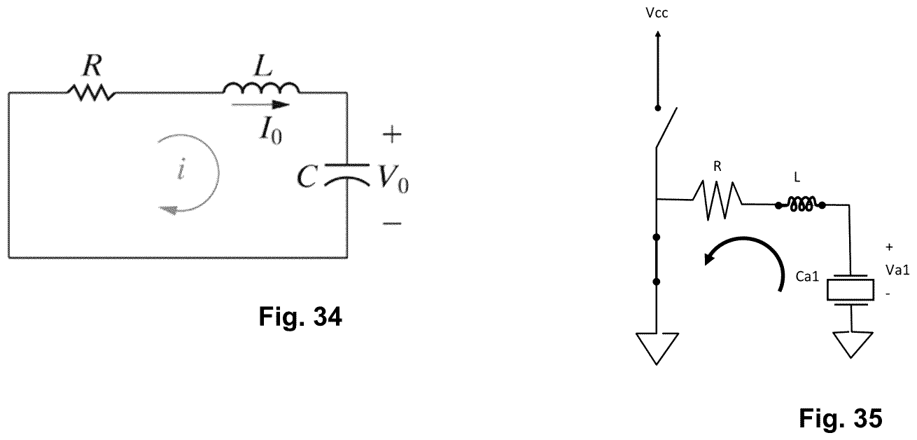

In all of the examples of the actuator voltage and PWM signal profiles shown in FIGS. 31 to 33, the period (T1) of the sawtooth signal (of the actuator voltage) is 33 μs and corresponds to a frequency f1 of 30 kHz. In FIG. 31, period T2 of the PWM signal is 0.4 μs (PWM frequency f2 is 2.5 MHz). In FIG. 32, period T2 of the PWM signal is 1.0 μs (1.0 MHz). In FIG. 33, period T2 of the PWM signal is 4.0 μs (0.25 MHz).

As can be seen, the frequency or period T2 of the PWM signal controls the profile of the slow phase (stick phase) of the sawtooth-like voltage signal at the actuators. High-frequency operation or the high-frequency properties of the switching elements that generate or amplify the PWM signal (e.g. GaN transistors) play a role in generating an advantageous voltage profile at the capacitive actuators. If the PWM signal frequency f2 is not sufficiently high, e.g., lower than 1 MHz, then the waveforms in the profile of the slow phase (slow charging or discharging) will be disturbed as shown in FIG. 33. On the other hand, the fast phase (slip phase) results from the natural response or the step response of the RLC circuit and is not affected.

The natural response of an RLC oscillating circuit is calculated below. For this we assume that at t=0, the current flowing through inductance L, is equal to 0 and the voltage at the capacitor of the capacitance C is equal to V₀. Then the equation

$$Ri + L \frac{di}{dt} + [ {V}_{o} + \frac{1}{C} {\int }_{0}^{t} i ( τ ) d τ ] = 0 \qquad ( 1 )$$

is fulfilled. Derivation results in

$$\frac{{d}^{2} i}{{dt}^{2}} + \frac{R}{L} \frac{di}{dt} + \frac{i}{LC} = 0 \qquad ( 2 )$$

and the characteristic equation is

$${s}^{2} + \frac{R}{L} s + \frac{1}{LC} = 0 \qquad ( 3 )$$

For the reason that experimentally observed voltage and current waveforms of the RLC circuits of capacitive piezoelectric actuator and inductance(s) exhibit a damped oscillation (ringing), it can be assumed that the system is a second-order system and is underdamped. This means that the characteristic equation has two complex conjugate roots s_{1,2}:

s_{1,2}=−α±α²+ω₀² (4)

where

$$α = \frac{R}{2 L} \qquad ( 5 )$$

is the damping factor,

$${ω}_{0} = \frac{1}{\sqrt{LC}} \qquad ( 6 )$$

is the resonant angular frequency and

ω_{d}=ω₀²−α² (7)

is the natural angular frequency or damping angular frequency. The parameters can be calculated from the initial conditions and the components of the circuit.

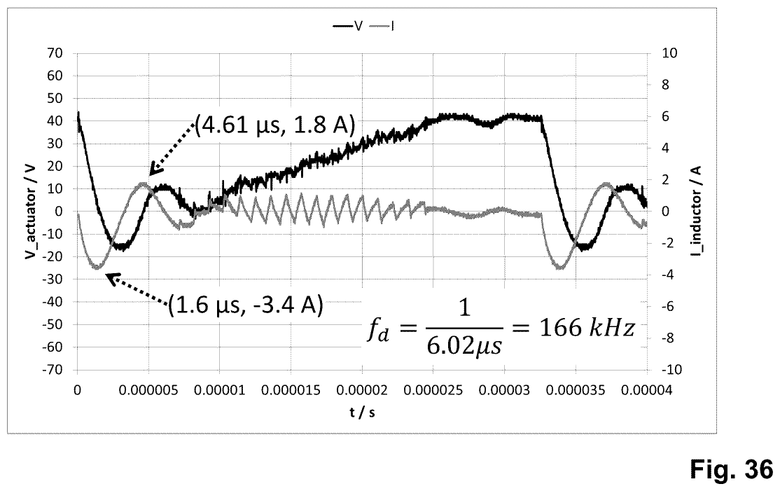

The half-bridge topology shown in FIG. 35 is given below as an example. The structure shown in FIG. 35 is equivalent to an RLC oscillating circuit with the parameters V_{cc}=40V=Va1=Vo at t=0, Ca1=C=70.0 nF, and L=7.0 μH. Equivalent resistance R can be determined from the measured waveforms of the current and voltage, as shown below with reference to FIG. 36.

With equation (6), the resonance frequency f₀ can be calculated as

$${f}_{0} = \frac{{ω}_{0}}{2 π} = 227 kHz \qquad ( 8 )$$

The damping angular frequency (or natural angular frequency) co d or damping frequency/natural frequency f_{d} can be experimentally read from the voltage or current waveform of FIG. 36. As can be seen in FIG. 36, the current minimum (−3.4 A) is at 1.6 μs and the current maximum (1.8 A) at 4.61 μs. The time difference between the occurrence of the minimum and the maximum corresponds to half the period of a damped oscillation, which results in a period of 6.02 s. f_{d}=166 kHz then arises for the damping frequency f_{d} as the reciprocal value of the period. For the damping angular frequency (or natural angular frequency), the following is obtained:

ω_{d}=2π*f_{d}=2π*166 kHz (9)

The symbol “*” presently denotes a scalar multiplication. With the measurement values presently illustrated, the current waveform should satisfy the following equation:

i(t)=B₂*e^{-αt}*Sin(2π*f_{d}*t) (10)

From the measurement points on the current waveform marked in FIG. 36, a can be found to be 211000(1/s), and rearranging equation (5),

R=α*2*L (11)

results in R=2.954Ω, which can be rounded to 3Ω.

With the parameters obtained by the above derivation, the current waveform satisfies the following equation:

i(t)__{model}=5*e^{-211000t}*Sin(2*π*166000*t) (12)

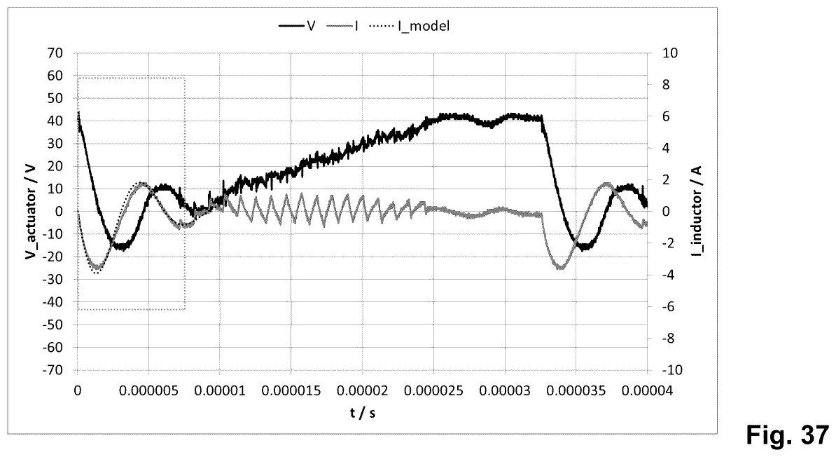

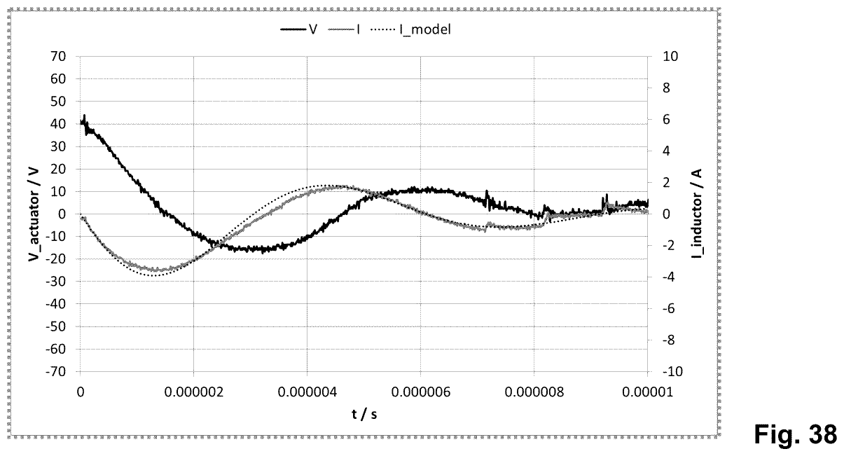

As can be seen in the plots shown in FIGS. 37 and 38, the modeled waveform I_model (dotted curve) according to equation (6) for the initial 5 to 6 μs fits the measured current waveform (FIG. 38 shows the highlighted section from FIG. 37). Slow charging starts later and the PWM signal prevails.

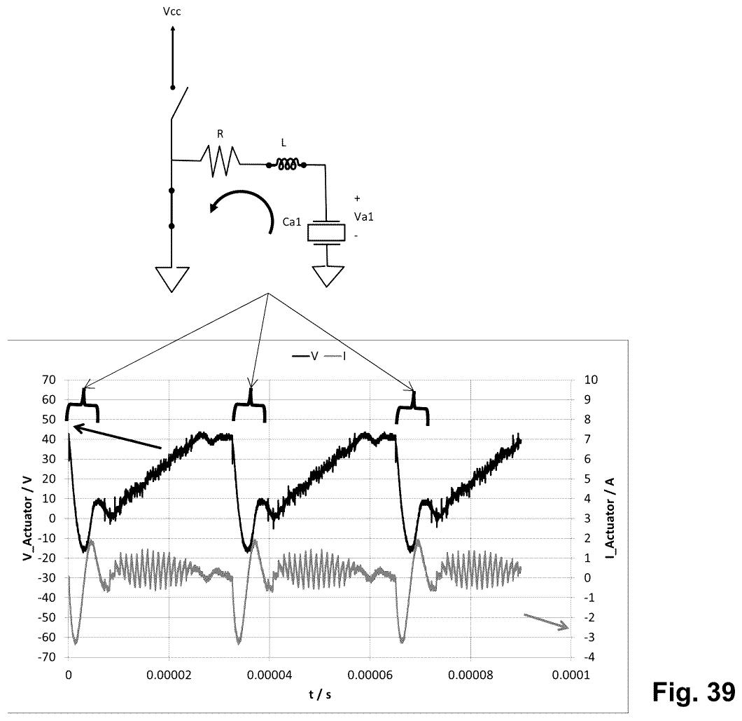

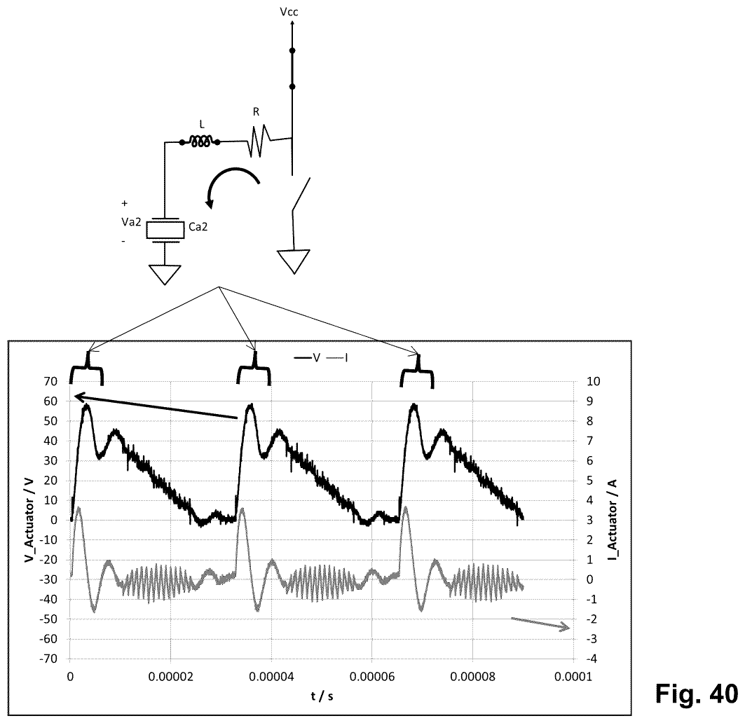

Measured voltage and current waveforms with associated configurations of RLC oscillating circuits with multilayer actuators with capacitances Ca1 and Ca2 during the fast phase (slip phase) are shown in FIG. 39 (fast discharging) and FIG. 40 (fast charging). During the slip phase, the natural response, as shown in FIG. 39, and the step response, as shown in Figure of an underdamped second-order RLC oscillating circuit configuration dominate for a duration of 5 to 6 μs.

In summary, the present invention relates to a control device and a control method for a piezoelectric inertia motor. In the stick phase, a first switching element and a second switching element are switched in directions opposite to one another by pulse width modulation, where a time component of a first switching state of on and off increases relative to a time component of a second switching state of on and off the pulse width modulation is filtered by the capacitive piezoelectric actuator and an inductance, and a first charging operation is carried out, and the time components of the first switching state and the second switching state are reversed at the beginning of a slip phase, and, as a result, a second charging operation opposite to the first charging operation is carried out at the capacitive piezoelectric actuator. By storing electromagnetic energy in the inductance, the configuration provided allows for the reduction of energy dissipation as heat and can contribute to an energy-efficient drive for inertial motors.

1-16. (canceled)

17. A control device for a piezoelectric inertia motor, comprising:
a capacitive piezoelectric actuator;
an inductance;
a first switching element connecting said capacitive piezoelectric actuator via said inductance to a first potential;
a second switching element connecting said capacitive piezoelectric actuator via said inductance to a second potential that differs from said first potential; and
a control element which is suitable for:
repeatedly switching said first switching element and said second switching element with pulse width modulation in directions opposite to one another in a stick phase of said piezoelectric inertia motor, where, in said pulse width modulation, a time component of a first switching state of switching states ON and OFF increases relative to a time component of a second switching state, and the pulse width modulation is filtered by said capacitive piezoelectric actuator and said inductance, and thereby carrying out a stepwise first charging operation of charging operations charging and discharging at said capacitive piezoelectric actuator; and
reversing the time component of the first switching state and the time component of the second switching state at the beginning of a slip phase of said piezoelectric inertia motor, and thereby carrying out a second charging operation in the direction opposite to the first charging operation at said capacitive piezoelectric actuator.

18. The control device according to claim 17, where a damped oscillating circuit containing said capacitive piezoelectric actuator and said inductance exhibits an overshoot in the transition from the slip phase to the stick phase.

19. The control device according to claim 17, where said inductance represents a first inductance and said first switching element connects said capacitive piezoelectric actuator via said first inductance to said first potential, comprising:
a second inductance;
a third switching element connecting said capacitive piezoelectric actuator via said second inductance to said first potential; and
a fourth switching element connecting said capacitive piezoelectric actuator via said second inductance to said second potential,
where said control element is suitable in the slip phase for switching said third switching element equally to said first switching element during the first charging operation and for switching said fourth switching element equally to said second switching element during the second charging process.

20. The control device according to claim 17, where said inductance represents a first inductance and said capacitive piezoelectric actuator is connected via said first inductance to said first switching element and to said second switching element, comprising:
a third inductance,
a fifth switching element connecting said capacitive piezoelectric actuator via said third inductance to said first potential, and
a sixth switching element connecting said capacitive piezoelectric actuator via said third inductance to said second potential,
where said control element is suitable for switching said fifth switching element equally to said second switching element and said sixth switching element equally to said first switching element.

21. The control device according to claim 17, where said control device is configured to carry out the first charging operation and the second charging operation without contact by inductive charging.

22. The control device according to claim 17, where said inductance represents a receiving inductance,
said control device contains a transmitting inductance, and said capacitive piezoelectric actuator is connected inductively via said receiving inductance and said transmitting inductance to said first switching element and to said second switching element.

23. The control device according to claim 22, where said control device is configured to carry out the first charging operation and the second charging operation without contact via said transmitting inductance and said receiving inductance.

24. The control device according to claim 22, where said capacitive piezoelectric actuator represents a first capacitive piezoelectric actuator, said receiving inductance represents a first receiving inductance, and
said control device contains a second transmitting inductance and said second capacitive piezoelectric actuator which is connected inductively via said second receiving inductance and said transmitting inductance to said first switching element and said second switching element, and
said first piezoelectric actuator and said second piezoelectric actuator are oriented in opposite polarization directions to one another.

25. The control device according to claim 22, comprising a transformer containing said transmitting inductance and said receiving inductance.

26. The control device according to one of the claim 20, where said capacitive piezoelectric actuator represents a first capacitive piezoelectric actuator, comprising a second capacitive piezoelectric actuator which is connected in parallel or in series with said first capacitive piezoelectric actuator in the opposite polarization direction.

27. The control device according to claim 17, where said capacitive piezoelectric actuator represents a first capacitive piezoelectric actuator and said inductance represents a first inductance, comprising:
a fourth inductance; and
a second capacitive piezoelectric actuator which is connected by a seventh switching element via said fourth inductance to said first potential and via an eighth switching element to said second potential; and
said control element is suitable for switching said seventh switching element in the direction opposite to said first switching element and for switching said eighth switching element in the direction opposite to said second switching element.

28. The control device according to claim 17, where a frequency of the pulse width modulation is at least 1 MHz.

29. The control device according to claim 28, where the frequency of the pulse width modulation is higher by a factor of at least 30 than a charging frequency of said capacitive piezoelectric actuator.

30. The control device according to claim 17, which comprises gallium nitride transistors as switching elements.

31. The control device according to claim 17, where the first charging operation and the second charging operation comprise:
charging operations charging and discharging; or
charging in the polarization direction of the capacitive piezoelectric actuator and charging in the direction opposite to the polarization direction of the capacitive piezoelectric actuator.

32. The control method for a piezoelectric inertia motor, comprising,
in a stick phase of said piezoelectric inertia motor:
repeatedly switching in directions opposite to one another a first switching element connecting a capacitive piezoelectric actuator via an inductance to a first potential and a second switching element connecting said capacitive piezoelectric actuator via said inductance to a second potential, with pulse width modulation, where, in the pulse width modulation, a time component of a first switching state of switching states ON and OFF increases relative to a time component of a second switching state and the pulse width modulation is filtered through said capacitive piezoelectric actuator and said inductance, whereby a stepwise first charging operation of charging operations charging and discharging is carried out at said capacitive piezoelectric actuator, and
at the beginning of a slip phase of said piezoelectric inertia motor:
reversing the time component of the first switching state and the time component of the second switching state, whereby a second charging operation in the direction opposite to the first charging operation is carried out at said capacitive piezoelectric actuator.

33. The control device according to claim 23, where said capacitive piezoelectric actuator represents a first capacitive piezoelectric actuator, said receiving inductance represents a first receiving inductance, and
said control device contains a second transmitting inductance and said second capacitive piezoelectric actuator which is connected inductively via said second receiving inductance and said transmitting inductance to said first switching element and said second switching element, and
said first piezoelectric actuator and said second piezoelectric actuator are oriented in opposite polarization directions to one another.

34. The control device according to one of the claim 21, where said capacitive piezoelectric actuator represents a first capacitive piezoelectric actuator, comprising a second capacitive piezoelectric actuator which is connected in parallel or in series with said first capacitive piezoelectric actuator in the opposite polarization direction.

35. The control device according to one of the claim 22, where said capacitive piezoelectric actuator represents a first capacitive piezoelectric actuator, comprising a second capacitive piezoelectric actuator which is connected in parallel or in series with said first capacitive piezoelectric actuator in the opposite polarization direction.

36. The control device according to one of the claim 23, where said capacitive piezoelectric actuator represents a first capacitive piezoelectric actuator, comprising a second capacitive piezoelectric actuator which is connected in parallel or in series with said first capacitive piezoelectric actuator in the opposite polarization direction.

37. The control device according to one of the claim 25, where said capacitive piezoelectric actuator represents a first capacitive piezoelectric actuator, comprising a second capacitive piezoelectric actuator which is connected in parallel or in series with said first capacitive piezoelectric actuator in the opposite polarization direction.
